(19) United States
(12) Patent Application Publication
(10) Pub. No.: US 2026/0211349 A1
(43) Pub. Date: Jul. 23, 2026

(54) TONER, PROCESS CARTRIDGE AND IMAGE-FORMING APPARATUS

(71) Applicant: CANON KABUSHIKI KAISHA, Tokyo (JP)

(72) Inventors: KENTA KAMIKURA, Kanagawa (JP); TAKUHO SATO, Shizuoka (JP); KAZUYUKI SATO, Kanagawa (JP); KENTA KATAYAMA, Shizuoka (JP); KAZUNARI OHIRA, Shizuoka (JP)

(21) Appl. No.: 19/445,190

(22) Filed: Jan. 9, 2026

(30) Foreign Application Priority Data
Jan. 17, 2025 (JP) 2025-006519
Dec. 11, 2025 (JP) 2025-245143

(51) Int. Cl. G03G 9/087

(52) U.S. Cl. CPC G03G 9/08711; G03G 9/08782; G03G 2221/183

(57) ABSTRACT

A toner comprises a toner particle containing a binder resin containing a styrene-acrylic copolymer, a block copolymer A including a styrene unit and a specific olefine unit, and an ester wax B having a specific structure.

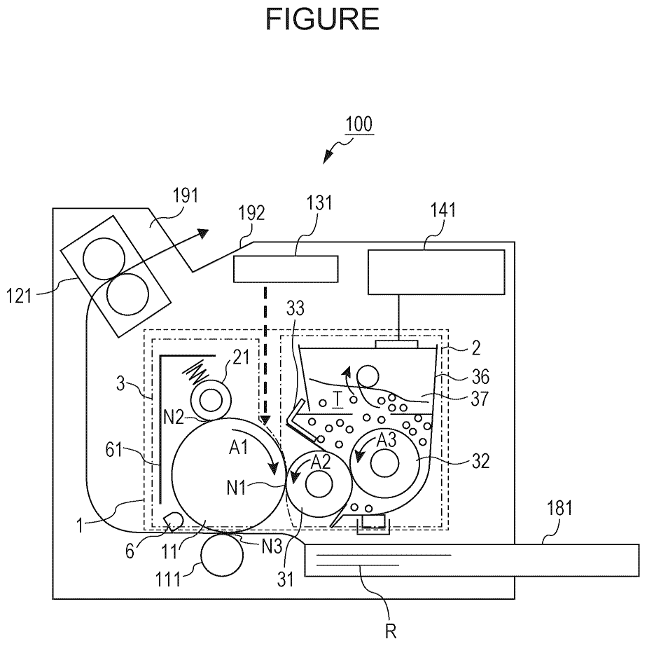

### BACKGROUND

### Field of the Technology

The present disclosure relates to a toner, a process cartridge, and an image-forming apparatus that are used in a recording method by electrophotography, an electrostatic recording method, or a toner jet system recording method.

### Description of the Related Art

In image formation by electrophotography, technologies for low-temperature fixation have been investigated in order to save energy and increase the printing speed.

As one method for low-temperature fixation, in technologies for reducing fixation temperature that have been widely investigated, a plasticizer highly miscible with a binder resin is added to a toner such that the plasticizer becomes miscible with the binder resin at the time of fixation. Examples of the plasticizer include crystalline resins such as a crystalline polyester resin and crystalline low-molecular materials such as an ester wax.

In particular, it is known that when a styrene acrylic resin is used as a binder resin, an excellent low-temperature fixation effect is obtained by using an ester wax as the plasticizer, and investigation for improving the low-temperature fixability is being widely carried out by controlling the position and dispersed state of the ester wax in the toner. International Publication No. WO 2019/065868 discloses a toner that includes an ester wax and a resin containing an isoprene unit for the purpose of improving the dispersibility of the ester wax in the toner.

At the same time, structures of ester waxes have also been investigated, and it is known that an ester compound of a diol and an aliphatic carboxylic acid and an ester compound of a dicarboxylic acid and an aliphatic alcohol have excellent miscibility with a styrene acrylic resin and are effective for improving the low-temperature fixability. International Publication No. WO 2013/047296 discloses a toner including a styrene acrylic resin as a binder resin and using an ester compound of a diol and an aliphatic carboxylic acid as a plasticizer.

### SUMMARY

However, the toner in International Publication No. WO 2019/065868 has low miscibility with an ester wax as the binder resin and thereby has a disadvantage poor fixability in a high-speed fixing process.

In contrast, the toner in International Publication No. WO 2013/047296 exhibits excellent fixability in a high-speed fixing process, but the gloss of images tends to be high, and the control of the gloss is difficult even if low gloss is required. In addition, it became clear that there are disadvantages that the gloss of an output image is decreased by precipitation of the ester compound to the image surface when the image is stored under specific conditions and that an image is soiled with the ester compound at the contact portion by touching the image.

Thus, a toner that can achieve all of the fixability in a high-speed fixing process, gloss control of images, and suppression of the decrease in the gloss has been required.

The present disclosure solves the above disadvantages and provides a toner that achieves the fixability in a high-speed fixing process, gloss control of images, and suppression of the decrease in the gloss of images.

The present disclosure relates to a toner comprising a toner particle containing a binder resin, a block copolymer A, and an ester wax B, wherein the binder resin contains a styrene-acrylic copolymer, a content of the styrene-acrylic copolymer in the binder resin is 50 mass % or more, the block copolymer A is a block copolymer including a polyolefine segment and a polystyrene segment, and the polyolefine segment includes an olefine unit C represented by any of formulae (1) to (4):

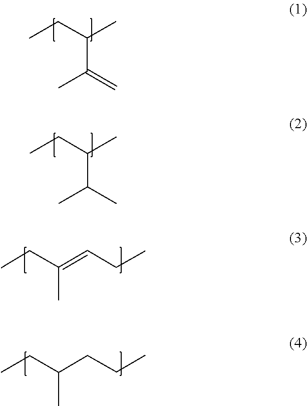

the ester wax B is miscible with 100 parts by mass of a styrene-n-butyl acrylate copolymer α having the following composition in an amount of 15.0 parts by mass or more at 100° C.: the styrene-n-butyl acrylate copolymer α is a copolymer of 75 parts by mass of a styrene monomer and 25 parts by mass of an n-butyl acrylate monomer, the styrene-n-butyl acrylate copolymer α has a weight-average molecular weight of 29,000 or more and 31,000 or less, and the ester wax B is an ester compound having a structure of formula (5) or a structure of formula (6):

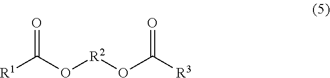

in formula (5), R¹ and R³ each independently represent an n-alkyl group having 13 to 21 carbon atoms, and R² represents an alkylene group having 2 to 8 carbon atoms;

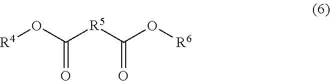

in formula (6), R⁴ and R⁶ each independently represent an n-alkyl group having 14 to 22 carbon atoms, and R⁵ represents a single bond or an alkylene group having 1 to 6 carbon atoms.

The present disclosure relates to a process cartridge attachable to and detachable from an image-forming apparatus, the process cartridge comprising a toner and a toner container accommodating the toner, wherein the toner comprises a toner particle containing a binder resin, a block copolymer A, and an ester wax B, the binder resin contains a styrene-acrylic copolymer, a content of the styrene-acrylic copolymer in the binder resin is 50 mass % or more, the block copolymer A is a block copolymer including a polyolefine segment and a polystyrene segment, and the polyolefine segment includes an olefine unit C represented by any of formulae (1) to (4), the ester wax B is miscible with 100 parts by mass of a styrene-n-butyl acrylate copolymer α having the following composition in an amount of 15.0 parts by mass or more at 100° C.: the styrene-n-butyl acrylate copolymer α is a copolymer of 75 parts by mass of a styrene monomer and 25 parts by mass of an n-butyl acrylate monomer, the styrene-n-butyl acrylate copolymer α has a weight-average molecular weight of 29,000 or more and 31,000 or less, and the ester wax B is an ester compound having a structure of formula (5) or a structure of formula (6).

The present disclosure relates to an image-forming apparatus comprising a toner, a toner carrier carrying the toner, an electrostatic latent image carrier, a charging device that charges the surface of the electrostatic latent image carrier by a charging member, an electrostatic latent image-forming device forming an electrostatic latent image on the charged electrostatic latent image carrier, a developing device for developing the electrostatic latent image using the toner to form a toner image on the electrostatic latent image carrier, a transfer device for transferring the toner image to a recording medium, and a fixing device for fixing the toner image transferred on the recording medium to the recording medium, wherein the toner comprises a toner particle containing a binder resin, a block copolymer A, and an ester wax B, the binder resin contains a styrene-acrylic copolymer, a content of the styrene-acrylic copolymer in the binder resin is 50 mass % or more, the block copolymer A is a block copolymer including a polyolefine segment and a polystyrene segment, and the polyolefine segment includes an olefine unit C represented by any of formulae (1) to (4), the ester wax B is miscible with 100 parts by mass of a styrene-n-butyl acrylate copolymer α having the following composition in an amount of 15.0 parts by mass or more at 100° C.: the styrene-n-butyl acrylate copolymer α is a copolymer of 75 parts by mass of a styrene monomer and 25 parts by mass of an n-butyl acrylate monomer, the styrene-n-butyl acrylate copolymer α has a weight-average molecular weight of 29,000 or more and 31,000 or less, and the ester wax B is an ester compound having a structure of formula (5) or a structure of formula (6).

Features of the present disclosure will become apparent from the following description of embodiments with reference to the attached drawing. The following description of embodiments is described by way of example.

### BRIEF DESCRIPTION OF THE DRAWING

FIGURE is a schematic view of an image-forming apparatus.

### DESCRIPTION OF THE EMBODIMENTS

In the present disclosure, the expressions “xx or more and yy or less” and “xx to yy” that represent numerical ranges mean a numerical range that includes the lower and upper limits as the endpoints, unless otherwise specified. When numerical ranges are stated in stages, the upper and lower limits of each numerical range can be combined in any way. In addition, in the present disclosure, for example, the expression such as “at least one selected from the group consisting of XX, YY and ZZ” means any of XX, YY, ZZ, a combination of XX and YY, a combination of XX and ZZ, a combination of YY and ZZ, or a combination of XX, YY and ZZ. When XX is a group, multiple items may be selected from XX, and the same is also applied to YY and ZZ. The monomer unit refers to a reacted form of a monomeric substance in a polymer.

### Characteristics of the Present Disclosure

The toner of the present disclosure is a toner comprising a binder resin and a toner particle containing a block copolymer A and an ester wax B, wherein the binder resin contains a styrene-acrylic copolymer, the content of the styrene-acrylic copolymer in the binder resin is 50 mass % or more, the block copolymer A is a block copolymer including a polyolefine segment and a polystyrene segment, the polyolefine segment includes an olefine unit C represented by any of the following formulae (1) to (4):

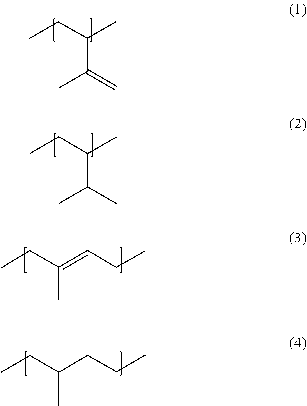

the ester wax B is miscible with 100 parts by mass of a styrene-n-butyl acrylate copolymer α having the following composition in an amount of 15.0 parts by mass or more at 100° C.: styrene-n-butyl acrylate copolymer α: a copolymer of 75 parts by mass of a styrene monomer and 25 parts by mass of an n-butyl acrylate monomer (weight-average molecular weight Mw: 29,000 or more and 31,000 or less), and the ester wax B is an ester compound having a structure of the following formula (5) or a structure of a following formula (6):

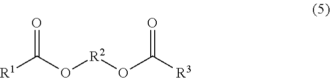

(in the formula (5), R¹ and R³ each independently represent an n-alkyl group having 13 to 21 carbon atoms, and R² represents an alkylene group having 2 to 8 carbon atoms);

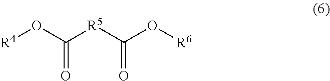

(in the formula (6), R⁴ and R⁶ each independently represent an n-alkyl group having 14 to 22 carbon atoms, and R⁵ represents a single bond or an alkylene group having 1 to 6 carbon atoms).

In the toner of the present disclosure, the factor for achieving both the fixability in a high-speed fixing process and suppression of the decrease in the gloss of images is not clear, but the present inventors infers as follows.

In general, the fixability-improving effect of a plasticizer becomes more excellent with an increase in the miscibility of the plasticizer with the binder resin. The miscibility of a plasticizer with a binder resin is affected by the affinity between the plasticizer and the binder resin and the molecular weight of the plasticizer, and the higher the affinity and the smaller the molecular weight of the plasticizer, the higher the miscibility tends to be.

The ester wax B having a structure of the formula (5) or (6) is a bifunctional ester compound having two ester bonds in the structure. The bifunctional ester compound has a higher polarity compared to a monofunctional ester compound having a similar molecular weight, and the polarity is similar to that of a styrene acrylic resin. Accordingly, the affinity with the styrene acrylic resin is high. The molecular weight is smaller compared to a tetrafunctional compound or hexafunctional compound having a similar melting point. Accordingly, a high effect of improving fixability can be obtained by using a styrene acrylic resin as a binder resin.

The ester wax B having a structure of the formula (5) or the structure of the formula (6) has an excellent fixability as described above but has high miscibility. Accordingly, the ester wax B tends to be miscible with the binder resin without crystalizing in an image immediately after the fixation. The thus-remaining ester wax in a miscible state without crystallizing gradually crystallizes under the influence of the surrounding temperature. The ester compound has high affinity with the styrene acrylic resin but is hydrophobic compared to the styrene acrylic resin and therefore has high affinity with air exhibiting similarly hydrophobicity. Accordingly, the crystal easily grows toward the image surface during crystallization. The ester wax having a structure of the formula (5) or (6), from the structural characteristics, tends to form a large crystal during crystallization. Accordingly, it is inferred that the ester compound remained in a miscible state in the image forms a large crystal on the image surface to decrease the smoothness of the image surface, and thereby a decrease in the gloss is caused.

The block copolymer A used in the present disclosure includes an olefine unit C having a high affinity with the ester wax B and a polystyrene segment having a high affinity with a styrene acrylic resin. Accordingly, the block copolymer A can be dispersed uniformly in the image immediately after the image formation due to the interaction between the polystyrene segment and the styrene acrylic resin. In addition, the ester wax B crystallizes from the polyolefine segment as the starting point and thereby can decrease the ester wax B remaining in a miscible state in the image while suppressing precipitation of the ester wax B to the image surface. In addition, the block copolymer A interacts with both the ester wax B and the styrene acrylic resin also when the ester wax B remaining in a miscible state is crystallized, and thereby it is possible to keep the ester wax B in the image. The above-described two actions are expected to suppress the decrease in the gloss.

In addition, the block copolymer A has a function as a thermoplastic elastomer. A thermoplastic elastomer exhibits a pseudo-crosslinked state by the cohesion between blocks at low temperature, but the molecular chains are unraveled at high temperature to dissolve the crosslinking structure. Accordingly, the block copolymer A increases the degree of freedom through unraveling of the molecular chains during the heating in a fixing process but forms a pseudo-crosslinking structure after fixation to stabilize the gloss of the image. This is expected to control the gloss.

### Constitutional Material and Physical Properties of Disclosed Toner

The materials that can be used in the toner of the present disclosure will now be described in detail.

### Block Copolymer A

The block copolymer A of the present disclosure is a block copolymer including a polyolefine segment containing olefine unit C and a polystyrene segment.

As long as the block copolymer A includes one or more polyolefine segments containing the olefine unit C and one or more polystyrene segments, the number of the polymer blocks and the binding form thereof are not particularly limited. Examples of the block copolymer A of the present disclosure include the followings. In the following examples, S represents a polystyrene segment, O represents a polyolefine segment containing the olefine unit C, and n represents an integer of 2 or more.
(a) a styrene-olefine copolymer represented by S—O;
(b) a styrene-olefine-styrene copolymer represented by S—O—S;
(c) an olefine-styrene-olefine copolymer represented by O—S—O;
(d) a styrene-olefine-styrene-olefine block copolymer represented by S—O—S—O; and
(e) a mixture of block copolymers in any combination of two or more of the above (a) to (d).

However, the block copolymer A of the present disclosure is not limited to the above (a) to (e) only. The block copolymer in the present disclosure can be, for example, the (a), (b), or (e) that is a mixture of block copolymers as a combination of the above (a) and (b).

The olefine unit C included in the polyolefine segment of the present disclosure has a structure of the following structural formula (1), (2), (3) or (4). The following structural formulae have characteristically a branch in the structure. Consequently, cohesiveness between olefine units C is decreased, and thereby interaction between the olefine unit C and the ester wax B is relatively increased to improve the effect of suppressing the decrease of gloss.

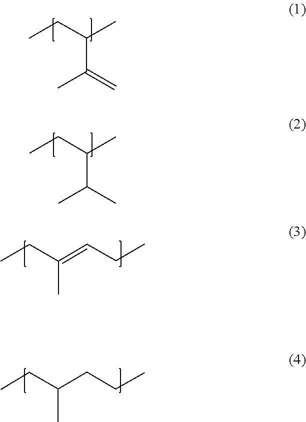

In particular, the structure can be that of the structural formula (1) or a unit of the formula (2) because of a further decrease in the cohesiveness between units, and the structure can be that of the structural formula (1) because of a higher affinity with the ester wax B.

The polyolefine segment may include an optional olefine unit in addition to the olefine unit C. Specifically, examples of the optional olefine unit include those derived from olefines such as ethylene, propylene, butene, and butadiene. In the polyolefine segment, the binding form between the olefine unit C and the optional olefine unit is not particularly limited, and blocks or random binding may be formed. The polyolefine segment is substantially composed of only the olefine unit C and the optional olefine unit. Specifically, 90% by mass or more of the polyolefine segment is the olefine unit C and the optional olefine unit. More preferably, 98% by mass or more of the polyolefine segment can be composed of the olefine unit C and the optional olefine unit. Even more preferably, the polyolefine segment can be composed of the olefine unit C and the optional olefine unit only.

The polystyrene segment is substantially composed of only styrene units. Specifically, 98% by mass or more of the polystyrene segment is styrene units. The polystyrene segment can be composed of styrene units only. Examples of the unit other than the styrene unit include styrene derivative units derived from styrene derivatives such as vinyl toluene and α-methylstyrene; unsaturated fatty acid units derived from unsaturated fatty acids such as acrylic acid and methacrylic acid; acrylic acid ester units derived from acrylic acid esters such as methyl acrylate, ethyl acrylate, propyl acrylate, n-butyl acrylate, 2-ethylhexyl acrylate, and dimethylaminoethyl acrylate; and methacrylic acid ester units derived from methacrylic acid esters such as methyl methacrylate, ethyl methacrylate, propyl methacrylate, butyl methacrylate, 2-ethylhexyl methacrylate, and dimethylaminoethyl methacrylate.

The block copolymer A can be manufactured according to an ordinary method. Examples of such a method for manufacturing a block copolymer include a method in which styrene and isoprene are each sequentially polymerized by an anion living polymerization method to form a polymer blocks and coupling is performed as needed by reacting a coupling agent. The structure of the structural formula (2) or (4) can be obtained by adding hydrogen to the obtained block copolymer under appropriate conditions.

In the present disclosure, a commercially available block copolymer can also be used. Examples of the commercially available block copolymer include trade names “Septon” and “Hybrar” (manufactured by Kuraray Co., Ltd.), trade name “Quintac” (manufactured by Zeon Corporation), trade name “JSR-SIS” (manufactured by JSR Corporation), trade name “Vector” (manufactured by DEXCO polymers, and trade names “Asaprene”, “Tufprene”, and “Tuftec” (manufactured by Asahi Kasei Chemicals Corporation).

The content rate of the olefine unit C in the block copolymer A may be 50 mass % or more and can be 50 mass % or more and 95 mass % or less, 60 mass % or more and 90 mass % or less, 70 mass % or more and 85 mass % or less, or 73 mass % or more and 80 mass % or less.

The content rate of the styrene unit in the block copolymer A may be 50 mass % or less and can be 5 mass % or more and 50 mass % or less, 10 mass % or more and 40 mass % or less, 15 mass % or more and 30 mass % or less, or 20 mass % or more and 27 mass % or less. The effects as a thermoplastic elastomer is enhanced by controlling the content of the styrene unit within the above range, and thereby the gloss-controlling effect is more increased.

The content proportion of the styrene unit in the block copolymer A can be measured by a known method. For example, the content proportion of the styrene unit in the block copolymer A can be measured in accordance with JIS K 7142 by measuring the refractive index of the block copolymer A with an Abbe refractometer.

The weight-average molecular weight (Mw) of the block copolymer A is not particularly limited, but can be 60,000 or more and 350,000 or less or 80,000 or more and 250,000 or less. Wen the block copolymer A has a weight-average molecular weight (Mw) of 60,000 or more and 350,000 or less, the toner has excellent heat-resistant storage stability and also good low-temperature fixability.

The content of the block copolymer A may be 2 parts by mass or more and 10 parts by mass or less based on 100 parts by mass of the binder resin and may be 2 parts by mass or more and 8 parts by mass or less, or 3 parts by mass or more and 7 parts by mass or less.

### Ester Wax B

The ester wax B of the present disclosure is miscible with 100 parts by mass of a styrene-n-butyl acrylate copolymer α having the composition shown below in an amount of 15.0 parts by mass or more at 100° C. Since the binder resin of the present disclosure includes 50 mass % or more of the styrene-acrylic copolymer, high miscibility with the styrene-n-butyl acrylate copolymer α causes rapid miscibility of a large amount of the ester wax B with the binder resin at the time of fixation. Accordingly, such an ester wax exhibits excellent low-temperature fixability. The miscible amount of the ester wax B at 100° C. with 100 parts by mass of a styrene-n-butyl acrylate copolymer α having the following composition is 15.0 parts by mass or more and can be 25.0 parts by mass or more or 35.0 parts by mass or more.
styrene-n-butyl acrylate copolymer α: a copolymer of 75 parts by mass of a styrene monomer and 25 parts by mass of an n-butyl acrylate monomer (weight-average molecular weight Mw: 29,000 or more and 31,000 or less).

The ester wax B of the present disclosure is an ester compound having a structure of the following formula (5) or a structure of a following formula (6) and can be an ester compound having a structure of the following formula (7):

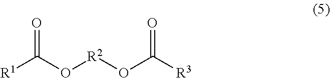

(in the formula (5), R¹ and R³ each independently represent an n-alkyl group having 13 to 21 carbon atoms, and R² represents an alkylene group having 2 to 8 carbon atoms);

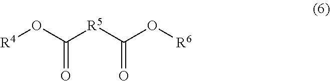

(in the formula (6), R⁴ and R⁶ each independently represent an n-alkyl group having 14 to 22 carbon atoms, and R⁵ represents a single bond or an alkylene group having 1 to 6 carbon atoms);

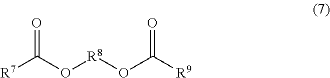

(in the formula (7), R⁷ and R⁹ each independently represent an n-alkyl group having 17 to 21 carbon atoms, and R⁸ represents an alkylene group having 2 carbon atoms).

Examples of the ester compound having a structure of the formulae (5) and (7) include, but not limited to, ethylene glycol distearate and ethylene glycol dibehenate. Examples of the ester compound having a structure of the formula (5) include, but not limited to, ethylene glycol dimyristate, ethylene glycol dipalmitate, butanediol distearate, and hexanediol distearate. Examples of the ester compound having a structure of the formula (6) include, but not limited to, distearyl adipate.

Regarding the relationship between the olefine unit C and the ester wax B, when the solubility parameter of the olefine unit C and the solubility parameter of the ester wax B are SPc (J/cm³)^{0.5} and SPb (J/cm³)^{0.5}, respectively, the value of a difference between SPb and SPc (SPb−SPc) can be 1.50 or more and 3.00 or less. When the value of a difference between SPb and SPc (SPb−SPc) is within the above range, the interaction between the ester wax B and the olefine unit C is in an appropriate range, and the gloss-suppressing effect and the effect of suppressing a decrease in the gloss are further enhanced.

The solubility parameter of the ester wax B can be 17.8 (J/cm³)^{0.5} or more and 18.5 (J/cm³)^{0.5} or less or 18.0 (J/cm³)^{0.5} or more and 18.3 (J/cm³)^{0.5} or less.

The solubility parameter (SP value) was determined according to the calculation method proposed by Fedors as follows.

The evaporation energy (Δei) (J/mol) and molar volume (Δvi) (cm³/mol) of the atoms or atomic groups in the molecular structure of the ester wax B or olefine unit C are determined from the table in “Polym. Eng. Sci., 14 (2), 147-154 (1974)”, and the solubility value (SP value) is calculated by the following equation:

$$SP value = {( \sum Δ ei / \sum Δ vi )}^{1 / 2} .$$

The molecular weight of the ester wax B can be 500 or more and 1,000 or less or 550 or more and 800 or less. When the molecular weight of the ester wax B is within the above range, the miscibility with the binder resin is easily adjusted within a suitable range.

The melting point of the ester wax B can be 60° C. or higher and 90° C. or less, 65° C. or higher and 85° C. or less, or 70° C. or higher and 80° C. or less. When the melting point of the ester wax B is within the above range, the storage stability of a toner can be improved while maintaining the low-temperature fixability of the toner.

### Other Wax

The toner of the present disclosure may include an optional wax, in addition to the above-described ester wax B, for the purpose of providing releasability.

Examples of the optional wax include petroleum hydrocarbon waxes, such as a paraffine wax, a microcrystalline wax, and petrolatum, and derivatives thereof, a montan wax and derivatives thereof, a hydrocarbon wax by a Fischer-Tropsch process and derivatives thereof, and ester waxes represented by a monofunctional ester wax represented by an ester of a monovalent alcohol and an aliphatic carboxylic acid, such as behenyl behenate, stearyl stearate, and palmityl palmitate and an ester of a monovalent carboxylic acid and an aliphatic alcohol;
a trifunctional ester wax represented by an ester of a trivalent alcohol and an aliphatic carboxylic acid, such as glycerin tribehenate, and an ester of a trivalent carboxylic acid and an aliphatic alcohol;
a tetrafunctional ester wax represented by an ester of a tetravalent alcohol and an aliphatic carboxylic acid, such as pentaerythritol tetrastearate and pentaerythritol tetrapalmitate, and an ester of a tetravalent carboxylic acid and an aliphatic alcohol;
a hexafunctional ester wax represented by an ester of a hexavalent alcohol and an aliphatic carboxylic acid, such as dipentaerythritol hexastearate and dipentaerythritol hexapalmitate, and an ester of a hexavalent carboxylic acid and an aliphatic alcohol;
an ester of a polyvalent alcohol and an aliphatic carboxylic acid, such as polyglycerin behenate, and an ester of a polycarboxylic acid and an aliphatic alcohol; and
a natural ester wax such as carnauba wax and rice wax, and a polyolefin hydrocarbon wax, such as polyethylene and polypropylene, and derivatives thereof, and a natural wax, such as carnauba wax and candelilla wax, and derivatives thereof. The derivatives include oxides, block copolymers with vinyl monomers, and graft-modified products.

The examples also include an alcohol such as higher aliphatic alcohol; a fatty acid, such as stearic acid and palmitic acid, and acid amides, esters, and ketones thereof; and hydrogenated castor oil and derivatives thereof, a plant wax, and an animal wax. These waxes can be used alone or in combination.

### Binder Resin

The binder resin of the present disclosure contains 50 mass % or more of a styrene-acrylic copolymer and can contain 90 mass % or more of a styrene-acrylic copolymer.

As the styrene-acrylic copolymer, known styrene-acrylic copolymers can be used without any limitation, as long as it is a copolymer of styrene and a monomer composition including at least one acrylic monomer selected from acrylic acid and its derivatives including an acrylic acid ester and methacrylic acid and its derivatives including a methacrylic acid ester. Specifically, the content of the styrene unit can be 60 mass % or more and 90 mass % or less based on the whole styrene-acrylic copolymer, and may be 70 mass % or more and 80 mass % or less. In addition, the content of the acrylic unit can be 10 mass % or more and 40 mass % or less or 20 mass % or more and 30 mass % or less.

Examples of the acrylic monomer include an acrylic acid ester, such as methyl acrylate and n-butyl acrylate; a methacrylic acid ester, such as methyl methacrylate, 2-hydroxyethyl methacrylate, t-butyl methacrylate, and 2-ethylhexyl methacrylate; and acrylic acid and methacrylic acid. In particular, an acrylic acid ester and a methacrylic acid ester can be used, n-butyl acrylate or methyl methacrylate may be used, and n-butyl acrylate may be used.

The styrene-acrylic copolymer of the present disclosure can include a known polymerizable monomer without any limitation, in addition to the above-mentioned styrene and acrylic monomer. Examples of the polymerizable monomer include a monofunctional monomer having one polymerizable unsaturated bond in the molecule, for example, an aromatic monomer, such as α-methylstyrene and vinyl toluene; an unsaturated dicarboxylic acid, such as maleic acid; an unsaturated dicarboxylic anhydride, such as maleic anhydride; a nitrile vinyl monomer, such as acrylonitrile; a halogen-containing vinyl monomer, such as vinyl chloride; and a nitrovinyl monomer, such as nitrostyrene; and polyfunctional monomer having multiple polymerizable unsaturated bonds in the molecule, such as divinylbenzene, 1,6-hexanediol diacrylate, 1,9-nonanediol diacrylate, and trimethylolpropane tri(meth)acrylate.

Furthermore, the toner having a good balance between the storage stability and fixability at low temperature can be obtained by including a macromonomer as a part of the polymerizable monomer. The macromonomer is a reactive oligomer or polymer having a polymerizable carbon-carbon unsaturated double bond at an end of the molecular chain and having a number average molecular weight of, usually, 1,000 or more and 30,000 or less. The macromonomer can be a monomer that forms a polymer having a glass transition temperature (hereinafter, also referred to as “Tg”) higher than the Tg of a polymer obtained by polymerizing a monovinyl monomer. The macromonomer can be used in an amount of 0.03 parts by mass or more and 5 parts by mass or less or 0.05 parts by mass or more and 1 part by mass or less based on 100 parts by mass of the monovinyl monomer.

As the binder resin of the present disclosure, a known binder resin can be used without any limitation in addition to the above-mentioned styrene-acrylic copolymer, and examples thereof include a polyester resin, a vinyl resin, a polyurethane resin, and a polyamide resin.

### Colorant

The toner of the present disclosure may contain a colorant. As the colorant, known pigments, dyes, and magnetic materials of black, yellow, magenta, cyan, and other colors can be used without any limitation.

Examples of the black colorant include a black pigment such as carbon black.

Examples of the yellow colorant include yellow pigments and yellow dyes, such as a monoazo compound; a disazo compound; a condensed azo compound; an isoindolinone compound; a benzimidazolone compound; an anthraquinone compound; an azometal complex; a methine compound; and an allylamide compound.

Specifically, the examples include C.I. Pigment Yellow 74, 93, 95, 109, 111, 128, 155, 174, 180, and 185 and C.I. Solvent Yellow 162.

Examples of the magenta colorant include magenta pigments and magenta dyes, such as a monoazo compound; a condensed azo compound; a diketopyrrolopyrrole compound; an anthraquinone compound; a quinacridone compound; a basic dye lake compound; a naphthol compound: a benzimidazolone compound; a thioindigo compound; and a perylene compound.

Specifically, the examples include C.I. Pigment Red 2, 3, 5, 6, 7, 23, 48:2, 48:3, 48:4, 57:1, 81:1, 122, 144, 146, 150, 166, 169, 177, 184, 185, 202, 206, 220, 221, 238, 254, and 269 and C.I. Pigment Violet 19.

Examples of the cyan colorant include cyan pigments and cyan dyes, such as a copper phthalocyanine compound and derivatives thereof; an anthraquinone compound; and a basic dye lake compound.

Specifically, the examples include C.I. Pigment Blue 1, 7, 15, 15:1, 15:2, 15:3, 15:4, 60, 62, and 66.

The content of the colorant can be 1.0 part by mass or more and 20.0 parts by mass or less based on 100.0 parts by mass of the binder resin.

The toner can be a magnetic toner by containing a magnetic material. In this case, the magnetic material can also serve as a colorant.

Examples of the magnetic material include an iron oxide represented by magnetite, hematite, and ferrite; and a metal, such as iron, cobalt, and nickel and alloys of these metals and a metal, such as aluminum, cobalt, copper, lead, magnesium, tin, zinc, antimony, beryllium, bismuth, cadmium, calcium, manganese, selenium, titanium, tungsten, and vanadium, and mixtures thereof.

When a magnetic material is used as a colorant, the content of the magnetic material can be 20.0 parts by mass or more and 120.0 parts by mass or less based on 100.0 parts by mass of the binder resin.

### Charge Control Agent

As another additive, a positive or negative charge control agent can be used in order to improve the chargeability of the toner. The charge control agent is not particularly limited as long as it is generally used as a charge control agent for toners. Among charge control agents, a positive or negative charge control resin can provide stable chargeability (charging stability) to a toner particle and therefore may be used.

Examples of the positive charge control agent include a nigrosine dye, a quaternary ammonium salt, a triaminotriphenylmethane compound, and an imidazole compound; a polyamine resin serving as a charge control resin; and a quaternary ammonium group-containing copolymer and a quaternary ammonium base-containing copolymer. In particular, a quaternary ammonium group-containing copolymer or a quaternary ammonium base-containing copolymer can be used.

Examples of the negative charge control agent include an azo dye containing a metal such as Cr, Co, Al, and Fe, a metal salicylate compound, a metal alkylsalicylate compound, and charge control resins such as a sulfonic acid group-containing copolymer, a sulfonate group-containing copolymer, a carboxylic acid group-containing copolymer, and a carboxylate group-containing copolymer.

The weight-average molecular weight (Mw) of the charge control resin is within a range of 5,000 or more and 30,000 or less as a polystyrene equivalent value measured by gel permeation chromatography (GPC) using tetrahydrofuran and can be in a range of 8,000 or more and 25,000 or less or 10,000 or more and 20,000 or less.

The copolymer proportion of the monomer having a functional group, such as a quaternary ammonium group and a sulfonate group, in the charge control resin is within a range of 0.5 mass % or more and 12 mass % or less and can be in a range of 1.0 mass % or more and 6 mass % or less or 1.5 mass % or more and 3 mass % or less.

In the present disclosure, the charge control agent is usually used at a proportion of 0.01 parts by mass or more and 10 parts by mass or less based on 100 parts by mass of the binder resin and can be at a proportion of 0.03 parts by mass or more and 8 parts by mass or less. When the addition amount of the charge control agent is 0.01 parts by mass or more and 10 parts by mass or less, both the possibilities of fogging occurrence and print-soiling occurrence are low.

### External Additive

The toner of the present disclosure may contain an external additive. The external additive is not particularly limited, and known external additives can be used.

Examples of the external additive include untreated silica microparticles, such as wet-process silica and dry-process silica, and surface-treated silica microparticles obtained by surface-treating the untreated silica microparticles with a treating agent such as a silane coupling agent, a titanium coupling agent, or a silicone oil; metal oxide microparticles, such as a titanium oxide microparticle, an aluminum oxide microparticle, and a zinc oxide microparticle, and metal oxide microparticles obtained by hydrophobization of metal oxides; fatty acid metal salts such as zinc stearate, calcium stearate, and zinc stearate; metal complexes of aromatic carboxylic acids such as salicylic acid, alkylsalicylic acid, dialkylsalicylic acid, naphthoic acid, and dicarboxylic acid; clay minerals such as hydrotalcite; and fluorine-based resin microparticles such as a vinylidene fluoride microparticle and a polytetrafluoroethylene microparticle.

The content of the external additive can be 0.1 parts by mass or more and 5.0 parts by mass or less based on 100.0 parts by mass of the toner particle.

### Domain of Ester Wax B

In the toner of the present disclosure, a cross-section of the toner particle observed with a scanning transmission electron microscope include domains of the ester wax B, and the average number of the domains can be 100 or more in one cross-section of the toner particle and may be 150 or more or 200 or more. The average major axis of the domains (r1) can be 1.00 μm or less, 0.50 μm or less, or 0.30 μm or less. Rapid miscibility of the ester wax B with the binder resin is caused in the fixing process by controlling the situation of the domains of the ester wax B to the above conditions, and thereby the fixability in a high-speed process is improved. In addition, since the precipitation of the ester wax B to the toner surface during storage of the toner can be suppressed, the storage stability of the toner is improved.

### Storage Elastic Modulus of Toner Particle

In the toner of the present disclosure, the toner particle can have a storage elastic modulus G′ (100) of 1.0×10⁴ Pa or more and 1.0×10⁵ Pa or less or 1.2×10⁴ Pa or more and 8.0×10⁴ Pa or less determined at 100° C. by dynamic viscoelasticity measurement. In addition, the toner particle in the toner of the present disclosure can have a storage elastic modulus G′ (60) of 1.0×10⁷ Pa or more and 1.5×10⁸ Pa or less or 1.2×10⁷ Pa or more and 1.0×10⁸ Pa or less determined at 60° C. by dynamic viscoelasticity measurement. The G′ (60) can be decreased by combining the block copolymer A and the ester wax B of the present disclosure, while maintaining the storage stability. In addition, the ratio of G′ (60) to G′(100), G′(60)/G′(100), can be 1.0×10² or more and 1.5×10³ or less. When the storage elastic moduli of the toner particle satisfy the above range and relationship, similar fixation states can be obtained over a wide temperature range. Accordingly, it is possible to suppress the occurrence of gloss difference (gloss unevenness) due to the temperature difference between the paper leading edge and the paper trailing edge at the time of fixation.

### Method for Obtaining the Toner of the Present Disclosure

Then, a method for obtaining the toner of the present disclosure will be described in detail below.

### Manufacturing Method of Toner Particle

The method for manufacturing the toner particle of the present disclosure is not particularly limited. For example, suspension polymerization, dissolution suspension, emulsion aggregation, or pulverization can be used. In particular, suspension polymerization can be used.

A method for obtaining a toner by suspension polymerization will be described in detail below.

### Process 1: Granulation Process

A polymerizable monomer composition including a polymerizable monomer, a colorant, a block copolymer A, and an ester wax B is dispersed in an aqueous medium containing a dispersion stabilizer, a polymerization initiator is added thereto, and droplets of the polymerizable monomer composition are then formed. The method for droplet formation is not particularly limited, but can be performed using an apparatus that can perform strong stirring, such as an “in-line” emulsion disperser (manufactured by Pacific Machinery & Engineering Co., Ltd., trade name: Milder) and a high-speed emulsion disperser (manufactured by PRIMIX Corporation, trade name: T.K. Homomixer MARK II type).

Examples of the polymerization initiator include persulfates such as potassium persulfate and ammonium persulfate; azo compounds such as 4,4′-azobis (4-cyanovaleric acid), 2,2′-azobis(2-methyl-N-(2-hydroxyethyl)propionamide), 2,2′-azobis (2-amidinopropane) dihydrochloride, 2,2′-azobis (2,4-dimethylvaleronitrile), and 2,2′-azobisisobutyronitrile; and organic peroxides such as di-t-butyl peroxide, benzoyl peroxide, t-butylperoxy-2-ethylhexanoate, t-hexylperoxy-2-ethylbutanoate, diisopropyl peroxydicarbonate, di-t-butyl peroxyisophthalate, and t-butyl peroxyisobutyrate. These initiators may be used alone or in combination of two or more. Among these initiators, organic peroxides can reduce the residual polymerizable monomer and have printing durability and therefore may be used.

Among the organic peroxides, since the initiator efficiency is high and the residual polymerizable monomer can be reduced, peroxy esters, particularly, a non-aromatic peroxy ester, i.e., a peroxy ester not having an aromatic ring may be used.

The polymerization initiator may be added, as described above, after dispersion of the polymerizable monomer composition in an aqueous medium and before droplet formation. Alternately, the polymerization initiator may be added to the polymerizable monomer composition before dispersion in an aqueous medium.

The addition amount of the polymerization initiator that is used in polymerization of a polymerizable monomer composition can be 0.1 parts by mass or more and 20 parts by mass or less based on 100 parts by mass of the monomer and can be 0.3 parts by mass or more and 15 parts by mass or less or 1 part by mass or more and 10 parts by mass or less.

In the present disclosure, the term “aqueous medium” refers to a medium whose main component is water.

In the present disclosure, the aqueous medium can contain a dispersion stabilizer. Examples of the dispersion stabilizer include inorganic compounds, e.g., sulfates, such as barium sulfate and calcium sulfate; carbonates, such as barium carbonate, calcium carbonate, and magnesium carbonate; phosphates, such as calcium phosphate; metal oxides, such as aluminum oxide and titanium oxide; and metal hydroxides, such as aluminum hydroxide, magnesium hydroxide, and ferric hydroxide; and organic compounds, e.g., water-soluble polymers, such as polyvinyl alcohol, methyl cellulose, and gelatin; anionic surfactants; nonionic surfactants; and amphoteric surfactants.

The above-mentioned dispersion stabilizers can be used alone or in combination of two or more. The addition amount of the dispersion stabilizer can be 0.1 parts by mass or more and 20 parts by mass or less based on 100 parts by mass of the polymerizable monomer and can be 0.2 parts by mass or more and 10 parts by mass or less.

Among the above-mentioned dispersion stabilizers, an inorganic compound, in particular, colloid of a water-insoluble metal hydroxide can be used. The particle size distribution of the toner particles can be narrowed and the amount of the residual dispersion stabilizer after washing can be decreased by using an inorganic compound, in particular, colloid of a water-insoluble metal hydroxide. Therefore, the resulting toner can clearly reproduce images and further does not deteriorate environmental stability.

### Process 2: Polymerization Process

Droplets are formed as in Process 1, and the obtained aqueous dispersion medium is heated to start polymerization to form an aqueous dispersion of a resin particle containing a binder resin, a colorant, a block copolymer A, and an ester wax B.

The polymerization temperature of the polymerizable monomer composition can be 50° C. or higher and may be 60° C. to 95° C. The reaction time of the polymerization can be 1 to 20 hours or 2 to 15 hours.

In order to perform polymerization in a stable dispersion of droplets of the polymerizable monomer composition, the polymerization reaction may be promoted while performing dispersion treatment by stirring in also the polymerization process following the Process 1.

The resin particle may be used as a toner directly or with the addition of an external additive, but can be used as a so-called core-shell type (or also referred to as “capsule type”) resin particle obtained by using the resin particle as a core layer and forming a shell layer that is different from the core layer on the outside of the resin particle. The core-shell type resin particle can keep balance between a decrease in the fixation temperature and prevention of aggregation during storage by coating the core layer composed of a material having a low softening point with a material having a higher softening point than that.

The method for manufacturing the core-shell type toner particle using the above-described resin particle is not particularly limited, and the toner particle can be manufactured by a known method. In-situ polymerization or a phase separation method can be used in terms of manufacturing efficiency.

A method for manufacturing a core-shell type resin particle by in-situ polymerization will now be described.

A core-shell type resin particle can be obtained by adding a polymerizable monomer for forming a shell layer (polymerizable monomer for a shell) and a polymerization initiator to an aqueous medium in which a toner particle is dispersed and performing polymerization.

As a polymerizable monomer for a shell, the same monomers as the above-mentioned polymerizable monomers can be used. In particular, monomers that can form a polymer having a Tg higher than 80° C., such as styrene, acrylonitrile, and methyl methacrylate, can be used alone or in combination of two or more.

Examples of the polymerization initiator that is used for polymerization of the polymerizable monomer for a shell include water-soluble polymerization initiators, e.g., metal persulfates, such as potassium persulfate and ammonium persulfate; azo initiators, such as 2,2′-azobis(2-methyl-N-(2-hydroxyethyl)propionamide) and 2,2′-azobis(2-methyl-N-(1,1-bis(hydroxymethyl)2-hydroxyethyl)propionamide). These initiators can be used alone or in combination of two or more. The amount of the polymerization initiator can be 0.1 parts by mass or more and 30 parts by mass or less based on 100 parts by mass of the polymerizable monomer for a shell or 1 part by mass or more and 20 parts by mass or less.

The polymerization temperature of the shell layer can be 50° C. or higher and may be 60° C. to 95° C. The reaction time of the polymerization can be 1 to 20 hours or 2 to 15 hours.

### Process 3: Volatile Component-Removing Process

In order to remove unreacted polymerizable monomer and so on from the resin particle dispersion after the completion of the polymerization process, a volatile component-removing process may be performed. The volatile component-removing process is performed by heating and stirring the resin particle dispersion in a stirring tank equipped with a stirring device. The heating conditions in the volatile component-removing process are appropriately controlled considering the vapor pressure of the component, such as the polymerizable monomer, to be removed. The volatile component-removing process can be performed at ordinary or reduced pressure.

### Process 4: Cooling Process

A cooling process may be performed to decrease the temperature of the resin particle dispersion after the volatile component-removing process before sending the dispersion to the next process. The state of the existing ester wax B can be changed by the conditions of the cooling process.

The conditions for temperature decrease and cooling can be determined by the cooling start temperature, the cooling rate, and the cooling end temperature.

The cooling start temperature can be any temperature higher than the crystallization temperature of the ester wax B in the binder resin. The fine crystal nucleus of the ester wax B is generated from the olefine unit C as the starting point by cooling when a cooling start temperature is within the above range, and the domain of the ester wax B grows around the crystal nucleus to promote the generation of a fine domain.

The cooling rate can be 1° C./sec or more. The curing of the binder resin by cooling is sufficiently quick by adjusting the cooling rate in the above range, and therefore the oriented growth of a crystal is inhibited even in a substance that easily forms a plate-like crystal such as the ester wax B, and a nearly spherical domain can be formed. Consequently, even if crystallization of the ester wax B occurs during the storage of the toner, anisotropy in crystallization is low, and thereby precipitation of the wax to the toner surface can be suppressed.

The cooling start temperature can be not lower than the melting point of the ester wax B. Generation of coarse domain of the ester wax B can be suppressed by controlling the cooling start temperature within the above range. The cooling start temperature can be higher than the melting point of the ester wax B by 10° C. or more.

The cooling end temperature can be the glass transition temperature (Tg) of the binder resin or less. The growth of the domain of the wax due to curing of the binder resin can be suppressed by controlling the cooling end temperature within the above range.

The state of the existing domain of the wax can be verified by observing a cross-section of the toner particle with a scanning transmission electron microscope.

### Process 5: High-Temperature Treatment Process

For the purpose of improving the crystallinity of the ester wax B in the resin particle, a high-temperature treatment process may be performed before sending the resin particle dispersion after the cooling process to the next process. The crystallinity of the ester wax B is enhanced by carrying out the high-temperature treatment process after the cooling process, and the storage stability of the toner can be improved.

The temperature of the high-temperature treatment process can be not lower than the glass transition temperature (Tg) of the binder resin.

The mobility of the ester wax B remaining in a miscible state is increased by adjusting the temperature of the high-temperature treatment process within the above range, and the crystallization is enhanced.

### Post-Process: Washing, Filtration, Dehydration, Drying, and Classification

The aqueous dispersion of the resin particle produced by the above processes is subjected to washing, filtration, dehydration, drying, and classification processes according to usual methods to obtain a toner particle.

As the above washing method, when an inorganic compound is used as the dispersion stabilizer, the dispersion stabilizer can be dissolved in water and removed by adding an acid or alkali to the aqueous dispersion of the toner particle. When colloid of a water-insoluble inorganic hydroxide is used as the dispersion stabilizer, the pH of the toner particle aqueous dispersion can be adjusted to 6.5 or less by adding an acid. As the acid to be added, inorganic acids such as sulfuric acid, hydrochloric acid, and nitric acid and organic acids such as formic acid and acetic acid can be used, and sulfuric acid has a high removal efficiency and places a small burden on manufacturing factories and therefore can be specially used.

As the methods for dehydration and filtration, various known methods can be used. The method is not particularly limited, and examples thereof include centrifugal filtration, vacuum filtration, and pressure filtration. The method for drying is also not particularly limited, and various methods can be used.

### Manufacturing Method of Toner

When a toner (toner product) is prepared by externally adding an external additive to the toner particle, the mixer for externally adding the external additive to the toner particle is not particularly limited, and any known mixer can be used whether dry or wet. Examples of the mixer include FM Mixer (manufactured by Nippon Coke & Engineering Co., Ltd.), Super Mixer (manufactured by Kawata Mfg. Co., Ltd.), NOBILTA (manufactured by Hosokawa Micron Corporation), and Hybridizer (manufactured by Nara Machinery Co., Ltd.). In order to control the coating state of the external additive, the toner can be prepared by adjusting the number of rotation of the external addition apparatus, treatment time, and the water temperature and amount of the jacket.

Examples of the sieve device that is used for separating coarse particles after the external addition include Ultrasonic (manufactured by Koeisangyo Co. Ltd.); Resonasieve and Gyro-Sifter (manufactured by Tokuju Corporation); Vibrasonic system (manufactured by Dalton Corporation); Soniclean (manufactured by Sintokogio, Ltd.); Turbo Screener (manufactured by Freund-Turbo Corporation); and Micro sifter (manufactured by Makino Mfg. Co., Ltd.).

### Measurement Method of Physical Properties

Methods for measuring physical properties of the toner and each material will be described below.

### Identification of Ester Wax B in Toner

(1) Method for Separating Wax from Toner

The melting point of the wax in a toner is measured using a thermal analyzer (DSC Q2000, manufactured by TA Instruments Japan Inc.). A toner (3.0 mg) is placed in the sample container of an aluminum pan (KIT NO. 0219-0041), and the sample container is put on a holder unit and set in an electric furnace. In a nitrogen atmosphere, a differential scanning calorimeter (DSC) curve is measured with a DSC by heating from 30° C. to 200° C. at a temperature rise rate of 10° C./min to calculate the melting point of the wax in the toner.

The toner is then dispersed in ethanol, which is a poor solvent for the toner, and is heated to a temperature higher than the melting point of the wax. At this time, pressure may be applied as needed. This procedure allows the wax above its melting point to be melted and extracted in the ethanol. When the temperature is increased and also pressure is applied, the wax can be separated from the toner by solid-liquid separation while applying pressure. Then, the extraction liquid is dried and solidified to obtain the wax. (2) Identification of wax by pyrolysis GCMS

Specific identification conditions of a wax by pyrolysis GCMS are shown below:
Mass spectrometer: Thermo Fisher Scientific Inc., ISQ
GC apparatus: Thermo Fisher Scientific Inc., Focus GC;
Ion source temperature: 250° C.;
Ionization method: EI;
Mass range: 50 to 1000 m/z;
Column: HP-5 MS [30 m]; and
Pyrolyzer: manufactured Japan Analytical Industry Co., Ltd., JPS-700.

A small amount of the wax separated by the extraction procedure and 1 μL of tetramethylammonium hydroxide (TMAH) are added to pyrofoil of 590° C. A produced sample is subjected to pyrolysis GCMS measurement under the above-mentioned conditions to obtain a peak derived from a wax. When the wax is an ester compound, respective peaks of the alcohol component and the carboxylic acid component are obtained. The alcohol component and the carboxylic acid component are detected as methylated products by the action of TMAH as a methylating agent. The molecular weight can also be obtained by analyzing the obtained peak and identifying the structure of the wax.

### Measurement Method of Melting Point

The melting point of a crystalline material (crystalline resin or wax) is measured using a differential scanning calorimeter (DSC) Q2000 (manufactured by TA Instruments Japan Inc.) under the following conditions:
Temperature rise rate: 10° C./min;
Measurement start temperature: 20° C.; and
Measurement end temperature: 180° C.

The temperature of the apparatus detecting unit is corrected using the melting points of indium and zinc, and the heat quantity is corrected using the heat of fusion of indium.

Specifically, 5 mg of a sample is precisely weighed and placed in an aluminum pan, and measurement is performed once. As a reference, a vacant aluminum pan is used. The peak temperature of the maximum endothermic peak at that time is defined as the melting point.

### Separation of Block Copolymer A

The chloroform-soluble matter in the toner particle is used as a sample. Measurement is carried out using a sample that is prepared by adjusting the concentration of the toner particle to 0.1 mass % with chloroform and filtrating the resulting solution through a PTFE filter with a 0.45 μm pore size. The gradient polymer LC measurement conditions are shown below:

Apparatus: ULTIMATE 3000 (manufactured by Thermo Fisher Scientific Inc.);
Mobile phase: A: chloroform (HPLC) and B: acetonitrile (HPLC);
Gradient: 2 min (A/B=0/100)→25 min (A/B=100/0) (the gradient of the change in mobile phase is adjusted to be linear);
Flow rate: 1.0 mL/min;
Injection: 0.1 mass %×20 μL;
Column: Tosoh TSKgel ODS (4.6 mmφ×150 mm×5 μm);
Column temperature: 40° C.; and
Detector: Corona charged particle detector (Corona-CAD) (manufactured by Thermo Fisher Scientific Inc.).

In a time-intensity graph obtained through the measurement, the resin components can be separated into two peaks in accordance with their polarities. It is possible to separate the resin into two types by thereafter carrying out the above-described measurement again and isolating fractions at the time when each peak reaches its trough. In this measurement, components with higher solubility in acetonitrile elute earlier. Accordingly, the binder resin and the block copolymer A are eluted in this order. Fragments containing the binder resin and the block copolymer A are collected by confirming the peaks corresponding to the respective resins and performing isolation at the timing of the peaks. Drying and concentration are performed to obtain a sample of the block copolymer A. Regarding toner particles containing components other than the binder resin and the block copolymer A, each fragment can be collected by carrying out the same procedure.

When a toner contains a release agent, it is necessary to separate the release agent form the toner. In the separation of the release agent, components having a molecular weight of 2,000 or less are separated as the release agent by recycle HPLC. The measurement method is shown below. First, a chloroform solution of the toner is produced by the above-described method. The obtained solution is filtrated through a solvent-resistant membrane filter with a pore size of 0.2 μm “Maishori Disk” (manufactured by Tosoh Corporation) to obtain a sample solution. The sample solution is adjusted such that the concentration of the component soluble in chloroform is 1.0 mass %. Measurement is carried out using this sample solution under the following conditions:
Apparatus: LC-Sakura NEXT (manufactured by Japan Analytical Industry Co., Ltd.);
Column: JAIGEL2H, 4H (manufactured by Japan Analytical Industry Co., Ltd.);
Eluent: chloroform;
Flow rate: 10.0 mL/min;
Oven temperature: 40.0° C.; and
Sample injection amount: 1.0 mL.

The molecular weight of the sample is calculated using a molecular weight calibration curve obtained using standard polystyrene resins (e.g., trade name “TSK standard polystyrene series F-850, F-450, F-288, F-128, F-80, F-40, F-20, F-10, F-4, F-2, F-1, A-5000, A-2500, A-1000, and A-500”, manufactured by Tosoh Corporation).

The release agent is removed from the toner by repeatedly performing isolation of components having a molecular weight of 2,000 or less using the thus-obtained molecular weight curve.

### Isolation of Olefine Unit C in Block Copolymer A, Verification of Block Structure of the Block Copolymer A and Measurement of Content Proportion

Identification of olefine unit C in the block copolymer A, verification of block structure of the block copolymer A and measurement of the content proportion are performed by 1H-NMR under the following conditions:
Measurement apparatus: FT NMR apparatus JNM-EX400 (manufactured by JEOL Ltd.);
Measurement frequency: 400 MHZ;
Pulse condition: 5.0 μs;
Frequency range: 10,500 Hz;
Cumulative number of times: 64 times;
Measurement temperature: 30° C.; and

Sample: prepared by placing 50 mg of a measurement sample in a sample tube having an inner diameter of 5 mm, adding deuterated chloroform (CDCl₃) as a solvent thereto, and dissolving it in a thermostatic chamber of 40° C.

The structure of each monomer unit is identified by analyzing the obtained ¹H-NMR chart. In the obtained ¹H-NMR chart, a peak that is independent of peaks attributed to constituents of other monomer units is selected from among peaks attributed to constituents of the olefine unit C, and the integral value S1 of this peak is calculated. With respect to other monomer units contained in the block copolymer A, the integral values are also similarly calculated.

When the monomer units constituting the block copolymer A are the olefine unit C and another monomer unit only, the content proportion of the olefine unit C is determined using the integral value S1 and an integral value S2 of a peak of the other monomer unit as follows. Note that n1 and n2 represent the numbers of hydrogen atoms included in constituents to which the peaks focused on are attributed in the respective portions.

$$Content proportion ( mol \% ) of olefine unit C = \{ ( S 1 / n 1 ) / ( ( S 1 / n 1 ) + ( S 2 / n 2 ) ) \} \times 100 .$$

Even if the block copolymer A includes two or more types of other monomer units, the content proportion of the olefine unit C can be calculated.

When a polymerizable monomer that does not include a hydrogen atom in the constituents other than a vinyl group is used, measurement is carried out using ¹³C-NMR and setting the measurement atomic nucleus to ¹³C in a single pulse mode, and calculation is performed as in ¹H-NMR. The content proportion of each monomer unit is converted to a value expressed in mass % by multiplying the molecular weight of each monomer unit by the proportion (mol %) of the monomer unit calculated by the above method.

The fact that the block copolymer A is a block copolymer having the polyolefin segment and the polystyrene segment can be confirmed from the ratio of the peak originating from the carbon atoms between olefin units, the peak originating from the carbon atoms between styrene units, and the peak originating from the carbon atoms between styrene unit and olefin unit in the ¹³C-NMR chart obtained by the above method. As an example, the carbon atom between olefin units is shown in Formula (8), the carbon atom between styrene units is shown in Formula (9), and the carbon atom between styrene unit and olefin unit is shown in Formula (10). In Formulas (8) to (10), the carbon atoms indicated by arrows correspond to the aforementioned carbon atoms.

Specifically, when a value (S_{I}/S_{SI}) of a ratio of an integral value (S_{I}) of the peak originating from the carbon atoms between olefin units to an integral value (S_{SI}) of the peak originating from the bond between styrene unit and olefin unit is 10 or more, and a value (S_{S}/S_{SI}) of a ratio of an integral value (S_{S}) of the peak originating from the carbon atoms between styrene units to an integral value (S_{SI}) of the peak originating from the bond between styrene unit and olefin unit is 5 or more, the block copolymer A is determined to be a block copolymer having the polyolefin segment and the polystyrene segment.

It is also possible to determine whether the polyolefin segment contains the olefin unit C from the peak position of the ¹³C-NMR chart.

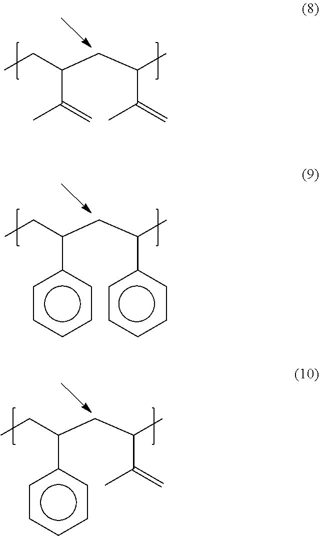

Observation of Cross-Section of Toner Particle with Scanning Transmission Electron Microscope

The domain of the ester wax B in the toner particle is verified by observing a cross-section of the toner particle using a scanning transmission electron microscope.

In a cross-section image of the toner particle using a scanning transmission electron microscope, the ester wax B is observed as a domain. The state of the existing ester compound is specified by measuring the number and shape of the domains of the ester wax B.

The procedure for observing a cross-section of a toner particle is as follows.

A toner particle is embedded in a visible light-curing embedding resin (trade name: D-800, manufactured New EM Co., Ltd.) and cut into a thickness of 70 nm with an ultrasonic ultramicrotome (trade name: UC7, manufactured by Leica Microsystems).

Ten samples in which the diameter of the cross-section of a toner particle is within weight-average particle diameter (D4)±2.0 μm are arbitrarily selected from the obtained thin section samples.

The selected thin section sample is stained using a vacuum dyeing apparatus (trade name: VSC4R1H, manufactured by Filgen, Inc.) in an RuO₄ gas atmosphere of 500 Pa for 15 minutes. Then, a STEM image is produced using a scanning transmission electron microscope (trade name: JEM2800, manufactured by JEOL Ltd.) in the scanning image mode.

The STEM image is obtained at a STEM probe size of 1 nm and an image size of 1024×1024 pixels by adjusting the conditions as follows.

### Detector Control Panel of Bright-Field Image:

Contrast: 1425; and
Brightness: 3750,

### Image Control Panel:

Contrast: 0.0;
Brightness: 0.5; and
Gamma: 1.00.

The obtained STEM image is binarized (threshold: 120/255 stages) using image processing software “Image-Pro Plus (manufactured by Media Cybernetics, Inc.)” to clarify the difference between the domain of the ester wax B and the region of the binder resin.

The white-looking part when the threshold value of binarization is 210 is the domain of the ester wax B.

### Identification of Domain of Ester Wax B

In a toner containing a release agent, the domain of the release agent on the STEM image may appear white, just like the domain of the ester wax B. In such a case, the domain is identified by the following procedure.

When crystalline materials are available as raw materials, their crystal structures are observed as in the above-described method for observing the ruthenium-stained toner particle cross-section with a transmission electron microscope to obtain images of the lamella structures of the respective crystals of the release agent and the ester wax B. These lamella structures are compared with the lamella structure of the domain in a cross-section of the toner particle. When the lamellar layer spacing error is 10% or less, the raw material forming the domain in a cross-section of the toner particle can be specified. Method for calculating average number and average major axis of domain of ester compound

In a STEM image of cross-sections of selected 10 toner particles, the domains of the ester wax B of the respective toner particles are counted, and the average value is defined as the average number of the domains.

In addition, in a STEM image of cross-sections of selected 10 toner particles, the maximum diameters of all domains included in the respective toner particles are measured, and the average value thereof is defined as the average major axis of the domains r1 (μm).

### Method for Measuring G′ (60) and G′ (100) of Toner Particle

The toner particle is sandwiched between a pair of plates of 8 mmφ (using parallel plates or cross-hatch plates) with a load of 20 g (a state in which the colored resin particles are uniformly arranged over an area of 8 mmφ and sandwiched between a pair of plates with a load of 20 g) to form a measurement sample. The dynamic viscoelasticity is measured with a dynamic viscoelasticity measurement apparatus (product name “ARES-G2”, manufactured by TA Instruments Japan Inc.) using a rotation plane type rheometer under conditions of measurement frequency of 24 Hz and a load of 20 g at a temperature rise rate of 5° C./min over a range of 45° C. to 150° C.

### Method for Measuring Glass Transition Temperature (Tg) of Binder Resin

The glass transition temperature (Tg) of the binder resin is measured using a differential scanning calorimeter analyzer “Q1000” (manufactured by TA Instruments Japan Inc.) in accordance with ASTM D3418-82.

The temperature of the apparatus detecting unit is corrected using the melting points of indium and zinc, and the heat quantity is corrected using the heat of fusion of indium. Specifically, 5 mg of a toner is precisely weighed and placed in an aluminum pan, and a vacant aluminum pan is used as a reference. Measurement is performed over a measurement range of 30° C. to 200° C. at a temperature rise rate of 1° C./min. In this temperature raising process, a specific heat variation is obtained in a temperature range of 40° C. to 100° C. The intersection point of the line at the midpoints of the baselines before and after the specific heat variation and differential heat curve is defined as the glass transition temperature (Tg) of the binder resin.

### Method for Measuring Weight-Average Particle Diameter (D4) and Number-Average Particle Diameter (D1)

The weight-average particle diameter (D4) and number-average particle diameter (D1) of a toner, toner particle, or toner base particles (hereinafter, also referred to as toner and so on) are calculated as follows.

As the measurement apparatus, a precision particle size distribution measuring device “Coulter Counter Multisizer 3” (registered trademark, manufactured by Beckman Coulter, Inc.) by an aperture impedance method equipped with an aperture tube of 100 μm is used.

The setting of the measurement conditions and analysis of the measurement data are performed using the accompanying dedicated software “Beckman Coulter Multisizer 3, Version 3.51” (manufactured by Beckman Coulter, Inc.). The measurement is performed at 25,000 effective measuring channels.

The aqueous electrolytic solution to be used for measurement can be obtained by dissolving special grade sodium chloride in deionized water at a concentration of 1.0%. Fr example, “ISOTON II” (manufactured by Beckman Coulter, Inc.) can be used.

Before the measurement and analysis, the dedicated software is set as follows.

On the “Change standard measurement method (SOMME)” screen of the dedicated software, the total count number of control mode is set to 50,000 particles, the number of measurements to 1, and the Kd value to a value obtained using “Standard particles 10.0 μm” (manufactured by Beckman Coulter, Inc.). The threshold and noise level are set automatically by pushing the “Threshold/noise level measurement button”. The current is set to 1,600 μA, the gain to 2, and the electrolyte solution to ISOTON II, and a check is entered for “Aperture tube flush after measurement”.

On the “Conversion settings from pulse to particle diameter” screen of the dedicated software, the bin interval is set to the logarithmic particle diameter, the particle diameter bins to 256, and the particle diameter range to 2 to 60 μm.

The specific measurement methods are as follows:
(1) 200.0 mL of the aqueous electrolytic solution is placed in a 250-mL round bottom glass beaker dedicated to the Multisizer 3, the beaker is set in the sample stand, and counter-clockwise stirring is performed with a stirrer rod at a rate of 24 rotations per second. Contamination and bubbles in the aperture tube are then removed by the “Aperture tube flush” function of the dedicated software;
(2) 30.0 mL of the aqueous electrolytic solution is placed in a 100-mL flat bottom glass beaker. As a dispersant, 0.3 mL of a dilution of “Contaminon N” (a 10% aqueous solution of a pH 7 neutral detergent for washing precise measuring instruments, comprising a nonionic surfactant, an anionic surfactant, and an organic builder, manufactured by FUJIFILM Wako Pure Chemical Corporation) diluted about 3 times by mass with deionized water is added to the beaker;
(3) An ultrasonic disperser “Ultrasonic Dispersion System Tetra 150” (manufactured by Nikkaki Bios Co., Ltd.) with an electrical output of 120 W equipped with two built-in oscillators having an oscillating frequency of 50 kHz with their phases shifted by 180° from each other is prepared. 3.3 L of deionized water is added to the water tank of the ultrasonic disperser, and 2.0 mL of Contaminon N is added to this water tank;
(4) The beaker of the above (2) is set in the beaker-fixing hole of the ultrasonic disperser, and the ultrasonic disperser is operated. The height position of the beaker is adjusted so as to maximize the resonant condition of the liquid surface of the aqueous electrolytic solution in the beaker;
(5) While the aqueous electrolytic solution in the beaker of the above (4) is being exposed to ultrasound, 10 mg of the toner and so on are added little by little to the aqueous electrolytic solution and dispersed. Ultrasonic dispersion treatment is continued for further 60 seconds. During the ultrasound dispersion, the water temperature in the water tank is appropriately adjusted to 10° C. or higher and 40° C. or less;
(6) The aqueous electrolytic solution of the above (5) with the toner and so on dispersed therein is dropwise added to the round bottom beaker of the above (1) set in the sample stand using a pipette to adjust the measurement concentration to 5%. Measurement is then performed until the number of measured particles reaches 50,000; and
(7) The measurement data are analyzed with the dedicated software included in the apparatus, and the weight-average particle diameter (D4) and the number-average particle diameter (D1) are calculated. The “Average diameter” on the “Analysis/volume statistical value (arithmetic mean)” screen when graph/volume % is set in the dedicated software is the weight-average particle diameter (D4).

The “Average diameter” on the “Analysis/number statistical value (arithmetic mean)” screen when graph/number % is set in the dedicated software is the number-average particle diameter (D1).

### Image-Forming Apparatus

FIGURE is a drawing illustrating a schematic structure of one example of the image-forming apparatus according to an aspect of the present disclosure. The whole configuration of the image-forming apparatus will be described referring to FIGURE. However, the components, dimension, and layout of this configuration example may be appropriately changed and do not limit the scope of this invention. FIGURE is a schematic cross-sectional view of an image-forming apparatus 100 that is a laser printer that can form monochromes (black single color images) using an electrophotographic system.

The image-forming apparatus 100 includes a drum-type (cylindrical) photosensitive member (photosensitive drum) 11 that can rotate as an electrostatic latent image carrier. Image-forming operation is started, and thereby the photosensitive member 11 is driven to rotate in the direction of the arrow A1 (clockwise direction) in the FIGURE by the driving force that is transmitted from the driving motor as a driving source constituting a driving unit.

The surface of the rotating photosensitive member 11 is uniformly charged to a predetermined potential of a predetermined polarity that is a normal polarity of the toner by a charging roller 21, which is a roller-type charging member, serving as a charging device. The surface (outer peripheral surface) of the charging roller 21 abuts on the surface (outer peripheral surface) of the photosensitive member 11 to form a charging portion N2.

This charging roller 21 abuts on the surface of the photosensitive member 11 by a predetermined pressure by applying a pressure to both ends of the conductive support in the rotation axial direction with a spring.

The charging roller 21 is rotated in accordance with the rotation of the photosensitive member 11. During the charging, a predetermined charging voltage (charging bias) is applied to the charging roller 21 from a charging power supply serving as a charging voltage application device (charging voltage application unit) at a predetermined timing. The uniformly charged surface (non-image area) of the photosensitive member 11 becomes dark potential.

The charged surface of the photosensitive member 11 is subjected to scanning exposure by an exposure device (laser exposure unit) 131 serving as an exposure device (electrostatic image-forming device) to form an electrostatic latent image (electrostatic image) on the photosensitive member 11. The exposure device 131 performs exposure by scanning a laser beam over the surface of the photosensitive member 11 along the main scanning direction of the photosensitive member 11 (approximately parallel to the rotation axial direction of the photosensitive member 11) depending on the image information (image data). In addition, the exposure device 131 repeats the exposure along the main scanning direction in synchronization with the timing along the sub-scanning direction (approximately parallel to the moving direction of the surface of the photosensitive member 11) depending on the image information. Consequently, an electrostatic latent image is formed on the photosensitive member 11. The exposed portion (image area, image portion), i.e., the exposed surface, of the photosensitive member 11 becomes a bright potential.

The electrostatic latent image formed on the photosensitive member 11 is developed (visualized) by supplying a toner T serving as a developing agent by a developing device (developing unit) 2 as a developing means to form a toner image (toner picture, developed image) on the photosensitive member 11. In the present disclosure, as the developing agent accommodated in the developing device 2, a single-component toner is used. The details of the toner are as described above.

The developing device 2 includes a developing roller 31 serving as a toner carrier (developing member). During the developing, the surface (outer peripheral surface) of the developing roller 31 abuts on the surface (outer peripheral surface) of the photosensitive member 11 to form a developing portion N1. In addition, during the developing, a predetermined developing voltage (developing bias) is applied to the developing roller 31 from a developing power supply serving as a developing voltage application device (developing voltage application unit) at a predetermined timing. The toner charged with the same polarity as the charge polarity of the photosensitive member 11 attaches the exposed portion (image area, image portion) on the photosensitive member 11 having an absolute value of potential reduced by the exposure after the uniform charging (reversal development system).

The development is performed by the potential difference (development contrast) formed between the development voltage applied to the developing roller 31 and the bright potential on the photosensitive member 11. Accordingly, a predetermined development voltage is applied to the developing roller 31. It is adjusted such that the surface potential formed on the surface of the developing roller 31 and the magnitude of the development voltage applied to the developing roller 31 are approximately the same. The developing roller 31 rotates in the direction of the arrow A2 (counterclockwise direction) in the FIGURE, which is the reverse direction of the photosensitive member 11 (the direction of movement at the contact portion is forward). The developing device 2 also will be further described later.

A transfer roller 111, which is a roller-type transfer member serving as a transfer device, is arranged so as to oppose the photosensitive member 11. The transfer roller 111 is pressed toward the photosensitive member 11 and forms a transfer unit (transfer nip) N3, which is the contact portion between the photosensitive member 11 and the transfer roller 111. In the transfer unit N3, the toner image formed on the photosensitive member 11 is transferred onto a recording material R nipped by the photosensitive member 11 and the transfer roller 111 and conveyed by the action of the transfer roller 111. During the transfer, a predetermined transfer voltage (transfer bias) is applied to the transfer roller 111 from a transfer power source as a transfer voltage application unit (transfer voltage applying portion) at a predetermined timing.

The sheet-like recording material (transfer material, recording medium, or sheet) R such as paper is supplied from the paper feeding unit (feeding unit) 181 to the transfer unit N3. The paper feeding unit 181 may include a cassette as a recording material-accommodating section, a conveyance roller as a conveyance member, and so on. The recording material R is conveyed to the transfer unit N3 in synchronization with the timing of the toner image on the photosensitive member 11.

The recording material R on which the toner image has been transferred is conveyed to a fixing device 121 serving as a fixing unit. The fixing device 121 fixes (melts or sticks) the toner image to the recording material R by applying heat and pressure to the recording material R carrying unfixed toner image. The recording material R with a fixed toner image is discharged (output) from a paper discharge unit (discharge unit) 191 and stacked on a tray 192 disposed on the top of the image-forming apparatus 100.

In this configuration example, the photosensitive member 11 and the charging roller 21 and developing device 2 serving as process units that act on the photosensitive member 11 integrally constitute a process cartridge 1 that is attachable to and detachable from the image-forming apparatus 100. The control unit 141 controlling the transfer roller 111, the exposure device 131, the fixing device 121, the pre-exposure device 6, and the developing device 2 and various power sources are attached to the image-forming apparatus 100. The image-forming apparatus and the process cartridge may include a cleaning blade (not shown) for cleaning the toner on the surface of the photosensitive member 11.

### Process Cartridge

The process cartridge 1 in this configuration example will then be further described.

The process cartridge 1 is configured by including a developing device (developing unit) 2 and a photosensitive member unit 3. As describe in detail below, the developing device 2 includes a developing roller 31, a supply roller 32, a developing blade 33, and a developing container 36 serving also as a developing agent accommodation section. The developing container 36 serves also as a development frame supporting the developing roller 31, the supply roller 32, and the developing blade 33.

The photosensitive member unit 3 includes a photosensitive member 11 and a charging roller 21 and supports them. The developing device 2 and the photosensitive member unit 3 are connected to each other such that the developing device 2 is swingable with respect to the photosensitive member unit 3 with a rotation axis approximately parallel to the rotation axial direction of the photosensitive member 11 as the center. More specifically, the process cartridge 1 is integrated by swingably connecting the developing container (development frame) 36 of the developing device 2 and the photosensitive member support container (photosensitive member unit frame) 61 of the photosensitive member unit 3 to each other.

Consequently, the developing device 2 can move to the contact position where the developing roller 31 abuts on the photosensitive member 11 and the separated position where the developing roller 31 is separated from the photosensitive member 11. The configuration in which the developing device 2 can move to the contact position and the separated position reduces unnecessary wear of the developing device 2 and the photosensitive member 11. That is, at the separated position, the rotation of the developing roller 31 and the supply roller 32 is stopped by stopping the operation of the developing device 2 to reduce the consumption of the toner, and the photosensitive member 11 and the developing roller 31 are separated from each other to suppress the wear of the charge transport layer.

### Developing Device

The developing device (developing unit) 2 in this configuration example will then be further described. The developing device 2 includes a developing roller 31, as a developing agent carrier (developing member), that carries and conveys the toner serving as a developing agent and supplies the toner to the electrostatic latent image formed on the surface of the photosensitive member 11 to develop an electrostatic latent image. The developing device 2 includes a supply roller (supply and removing roller) 32, as a developing agent feed member (developing agent supply and removal member), that supplies the toner to the developing roller 31 and also removes the toner from the developing roller 31. The supply roller 32 rotates in the direction of the arrow A3.

The developing device 2 includes a developing blade 33 that serves as a control member controlling the amount of the toner supplied on the developing roller 31 to a predetermined amount. The developing device 2 includes a developing container 36 that forms a toner accommodation section (toner container) 37 therein. A single-component toner serving as a developing agent is accommodated in the toner accommodation section 37.

### EXAMPLES

The present disclosure will be more specifically described by Examples below. However, Examples below do not limit the present disclosure in any way. The toner and manufacturing method of the toner will be described below. All “parts” in Examples and Comparative Examples are by mass unless otherwise specified.

### Manufacturing Example of Toner

### Toner 1

### Process 1: Granulation Process

Styrene: 77 parts;
n-Butyl acrylate: 23 parts;
Carbon black (manufactured by Mitsubishi Chemical Corporation, trade name: #25B): 7 parts;
Divinylbenzene: 0.6 parts;
t-Dodecyl mercaptan: 1.2 parts; and
Polymethacrylic acid ester macromonomer (manufactured by Toagosei Co., Ltd., trade name: AA6, Tg=94° C.): 0.3 parts,

These materials were mixed and subjected to wet grinding using a media stirring type wet pulverizer.
Charge control resin (manufactured by Fujikura Kasei Co., Ltd., trade name: Acrybase FCA-207P, styrene acrylic resin): 1 part;
Block copolymer A-1 (manufactured by Kuraray Co., Ltd., trade name: Hybrar 5125, including the structure of formula (1) as the olefine unit C): 5 parts; and
Ester wax B-1 (ethylene glycol distearate, melting point: 76° C.): 15 parts were then added to the mixture and mixed to obtain a polymerizable monomer composition.

Separately, in a stirring tank, an aqueous solution obtained by dissolving 4.1 parts of sodium hydroxide (alkali metal hydroxide) in 50 parts of deionized water is gradually added to an aqueous solution obtained by dissolving 7.4 parts of magnesium chloride (water-soluble polyvalent metal salt) in 250 parts of deionized water while stirring at room temperature to prepare a magnesium hydroxide colloid (water-insoluble metal hydroxide colloid) dispersion.

Separately, 2 parts of methyl methacrylate (Tg=105° C.) serving as a polymerizable monomer for a shell and 65 parts of deionized water were subjected to a fine dispersion treatment with an ultrasonic emulsifier to obtain an aqueous dispersion of the polymerizable monomer for a shell.

The droplets of the polymerizable monomer for a shell had a particle diameter D90 of 1.6 μm.

The polymerizable monomer composition was charged to the magnesium hydroxide colloid dispersion obtained above, followed by stirring until the droplets are stabilized. Six parts of t-butyl peroxyisobutyrate (manufactured by NOF Corporation, trade name: Perbutyl IB) serving as a polymerization initiator was added thereto, and the mixture was then subjected to high-shear stirring at a rotation number of 15,000 rpm using an in-line emulsion disperser (manufactured by Pacific Machinery & Engineering Co., Ltd., trade name: Milder) to perform dispersion while circulating to form droplets of the polymerizable monomer composition.

### Process 2: Polymerization Process

Then, 1 part of sodium tetraborate decahydrate was added to the aqueous dispersion of the polymerizable monomer composition in the droplet form, the mixture was placed in a reaction vessel equipped with a stirring blade, and the temperature was increased to 85° C. to perform polymerization. After the polymerization conversion ratio reached almost 100%, the aqueous dispersion of the polymerizable monomer for a shell and 0.3 parts of 2,2′-azobis(2-methyl-N-(2-hydroxyethyl)propionamide) (manufactured by FUJIFILM Wako Pure Chemical Corporation, trade name: VA-086, water-soluble) serving as a polymerization initiator for a shell were added to the reaction vessel. The polymerization was continued for further 4 hours to obtain a resin particle dispersion.

In the above process, a resin particle excluding carbon black, charge control resin, block copolymer A-1, and ester wax B-1 was formed, and the glass transition temperature of the obtained resin particle (binder resin equivalent) was measured. The glass transition temperature was 53° C.

### Process 3: Volatile Matter-Removing Process

The temperature of the resin particle dispersion was increased to 100° C. while continuing stirring, and a volatile matter-removing process was performed for 2 hours while maintaining the temperature.

### Process 4: Cooling Process

Subsequently, a cooling process for cooling the resin particle dispersion to 40° C. at a rate of 4.0° C./sec was performed.

### Process 5: High-Temperature Treatment Process

Then, the resin particle dispersion was heated to 55° C. and was subjected to a high-temperature treatment process for 3 hours while maintaining the temperature. Subsequently, the temperature was increased to 25° C. to obtain a toner particle dispersion.

### Post-Process: Filtration, Washing, and Drying Process

The toner particle dispersion was washed with dilute sulfuric acid (25° C., for 10 minutes) to adjust the pH to 4.5 or less. Subsequently, water was separated by filtration, then 200 parts of deionized water was newly added thereto to make a slurry again, and water-washing treatment (washing, filtration, and dehydration) was repeated several times at room temperature (25° C.). The resulting solid content was separated by filtration and was then vacuum-dried to obtain a toner particle 1.

To 100 parts of the above-obtained toner particle 1, 1 part of a hydrophobized silica microparticle (number average primary particle diameter: 7 nm) and 1 part of a hydrophobized silica microparticle (number average primary particle diameter: 35 nm) were added as external additives. The mixture was subjected to external addition treatment by mixing and stirring using a high-speed stirrer (manufactured by Nippon Coke & Engineering Co., Ltd., trade name: Henschel Mixer) to obtain a toner 1. The physical properties of the toner particle 1 and toner 1 are shown in Table 4.

### Toners 2 to 24

Toners 2 to 24 were obtained as in the manufacturing example of toner 1 except that raw materials including the block copolymer A shown in Table 1 and the ester wax B shown in Table 2 and manufacturing conditions were changed to those shown in Table 3. The physical properties of the toner particles 2 to 24 and toners 2 to 24 are shown in Table 4.

TABLE 1

| | | | Content | Content | | |
|---|---|---|---|---|---|---|
| | | | rate of | rate of | | |
| | | | olefine | styrene | | |
| | | Olefin unit | unit C | unit | Block | SPc |
| | Product name | C | (mass %) | (mass %) | structure | (J/cm³)^{0.5} |
| Block copolymer | Hybrar 5125 | Formula (1) | 80 | 20 | S-O-S | 16.51 |
| A-1 | | | | | | |
| Block copolymer | Hybrar 7125F | Formula (2) | 80 | 20 | S-O-S | 15.43 |
| A-2 | | | | | | |
| Block copolymer | Septon 2002 | Formula (4) | 70 | 30 | S-O-S | 16.08 |
| A-3 | | | | | | |
| Block copolymer | Hybrar 7311F | Formula (2) | 80 | 12 | S-O-S | 15.43 |
| A-4 | | | | | | |
| Block copolymer | Septon 4033 | Formula (4) | 50 | 30 | S-O-S | 16.08 |
| A-5 | | | | | | |
| Block copolymer | Septon 1020 | Formula (4) | 64 | 36 | S-O | 16.08 |
| A-6 | | | | | | |
| Block copolymer | Polystyrene- | Formula (3) | 86 | 14 | S-O-S | 16.85 |
| A-7 | block- | | | | | |
| | polyisoprene- | | | | | |
| | block- | | | | | |
| | polystyrene | | | | | |
| Block copolymer | Septon 8004 | — | 0 | 31 | S-O-S | — |
| A-8 | | | | | | |

In Table 1, Hybrar 5125, Hybrar 7125F, Septon 2002, Hybrar 7311F, Septon 4033, Septon 1020, and Septon 8004 are manufactured by Kuraray, and polystyrene-block-polyisoprene-block-polystyrene (catalog number 432393) is manufactured by Sigma-Aldrich.

TABLE 2

| | | | | Melting | | Miscible |
|---|---|---|---|---|---|---|
| | | | SPb | point | Molecular | amount |
| | Material name | Structure | (J/cm³)^{0.5} | (° C.) | weight | (parts) |
| Ester wax | Ethylene glycol | (7) | 18.11 | 76 | 593 | 45 |
| B-1 | distearate | | | | | |
| Ester wax | Ethylene glycol | (7) | 18.01 | 83 | 707 | 15 |
| B-2 | dibehenate | | | | | |
| Ester wax | Ethylene glycol | (6) | 18.16 | 69 | 539 | 100 |
| B-3 | dipalmitate | | | | | |
| Ester wax | Butanediol distearate | (6) | 18.08 | 68 | 623 | 35 |
| B-4 | | | | | | |
| Ester wax | hexanediol distearate | (6) | 18.05 | 63 | 651 | 25 |
| B-5 | | | | | | |
| Ester wax | Distearyl adipate | (5) | 17.97 | 72 | 763 | 9 |
| B-6 | | | | | | |
| Ester wax | Behenyl stearate | — | 17.57 | 67 | 593 | 7.5 |
| B-7 | | | | | | |
| Ester wax | Behenyl behenate | — | 17.56 | 73 | 649 | 5 |
| B-8 | | | | | | |
| Ester wax | Pentaerythritol | — | 18.15 | 82 | 1426 | 1 |
| B-9 | tetrabehenate | | | | | |

In Table 2, miscible amount (parts) represents the miscible amount with respect to 100 parts by mass of the styrene-n-butyl acrylate copolymer α.

TABLE 3

| | | | | | | | | High- |
|---|---|---|---|---|---|---|---|---|
| | | | | | Tg of | Cooling process | | temperature |
| | Styrene/ | | | | binding | Before → | Cooling | treatment |
| | n-BA | Divinylbenzene | Block copolymer | Ester wax | resin | after | rate | process |
| Toner | 77/23 | 0.6 | Block copolymer | Ester wax | 53° C. | 100° C.→ | 4° C./sec | Y |
| 1 | | | A-1 | B-1 | | 40° C. | | |
| Toner | 77/23 | 0.6 | Block copolymer | Ester wax | 53° C. | 100° C.→ | 4° C./sec | Y |
| 2 | | | A-2 | B-1 | | 40° C. | | |
| Toner | 77/23 | 0.6 | Block copolymer | Ester wax | 53° C. | 100° C.→ | 4° C./sec | Y |
| 3 | | | A-3 | B-1 | | 40° C. | | |
| Toner | 77/23 | 0.6 | Block copolymer | Ester wax | 53° C. | 100° C.→ | 4° C./sec | Y |
| 4 | | | A-4 | B-1 | | 40° C. | | |
| Toner | 77/23 | 0.6 | Block copolymer | Ester wax | 53° C. | 100° C.→ | 4° C./sec | Y |
| 5 | | | A-5 | B-1 | | 40° C. | | |
| Toner | 77/23 | 0.6 | Block copolymer | Ester wax | 53° C. | 100° C.→ | 4° C./sec | Y |
| 6 | | | A-6 | B-1 | | 40° C. | | |
| Toner | 77/23 | 0.6 | Block copolymer | Ester wax | 53° C. | 100° C.→ | 4° C./sec | Y |
| 7 | | | A-1 | B-2 | | 40° C. | | |
| Toner | 77/23 | 0.6 | Block copolymer | Ester wax | 53° C. | 100° C.→ | 4° C./sec | Y |
| 8 | | | A-1 | B-3 | | 40° C. | | |
| Toner | 77/23 | 0.6 | Block copolymer | Ester wax | 53° C. | 100° C.→ | 4° C./sec | Y |
| 9 | | | A-1 | B-4 | | 40° C. | | |
| Toner | 77/23 | 0.6 | Block copolymer | Ester wax | 53° C. | 100° C.→ | 4° C./sec | Y |
| 10 | | | A-1 | B-5 | | 40° C. | | |
| Toner | 77/23 | 0.6 | Block copolymer | Ester wax | 53° C. | 100° C.→ | 1° C./sec | Y |
| 11 | | | A-1 | B-3 | | 40° C. | | |
| Toner | 77/23 | 0.6 | Block copolymer | Ester wax | 53° C. | 100° C.→ | 0.01° C./sec | Y |
| 12 | | | A-1 | B-3 | | 40° C. | | |
| Toner | 77/23 | 0.6 | Block copolymer | Ester wax | 53° C. | 100° C.→ | 0.01° C./sec | N |
| 13 | | | A-1 | B-3 | | 40° C. | | |
| Toner | 77/23 | 1 | Block copolymer | Ester wax | 53° C. | 100° C.→ | 4° C./sec | Y |
| 14 | | | A-1 | B-1 | | 40° C. | | |
| Toner | 77/23 | 0.2 | Block copolymer | Ester wax | 53° C. | 100° C.→ | 4° C./sec | Y |
| 15 | | | A-1 | B-1 | | 40° C. | | |
| Toner | 80/20 | 0.6 | Block copolymer | Ester wax | 56° C. | 100° C.→ | 4° C./sec | Y |
| 16 | | | A-1 | B-1 | | 40° C. | | |
| Toner | 80/20 | 1 | Block copolymer | Ester wax | 56° C. | 100° C.→ | 4° C./sec | Y |
| 17 | | | A-1 | B-1 | | 40° C. | | |
| Toner | 77/23 | 0.6 | Block copolymer | Ester wax | 53° C. | 100° C.→ | 4° C./sec | Y |
| 18 | | | A-7 | B-1 | | 40° C. | | |
| Toner | 77/23 | 0.6 | Block copolymer | Ester wax | 53° C. | 100° C.→ | 0.01° C./sec | N |
| 19 | | | A-1 | B-6 | | 40° C. | | |
| Toner | 77/23 | 0.6 | Block copolymer | Ester wax | 53° C. | 100° C.→ | 0.01° C./sec | N |
| 20 | | | A-1 | B-7 | | 40° C. | | |
| Toner | 77/23 | 0.6 | Block copolymer | Ester wax | 53° C. | 100° C.→ | 0.01° C./sec | N |
| 21 | | | A-1 | B-8 | | 40° C. | | |
| Toner | 77/23 | 0.6 | Block copolymer | Ester wax | 53° C. | 100° C.→ | 0.01° C./sec | N |
| 22 | | | A-1 | B-9 | | 40° C. | | |
| Toner | 77/23 | 0.6 | Block copolymer | Ester wax | 53° C. | 100° C.→ | 0.01° C./sec | N |
| 23 | | | A-8 | B-3 | | 40° C. | | |
| Toner | 77/23 | 0.6 | — | Ester wax | 53° C. | 100° C.→ | 0.01° C./sec | N |
| 24 | | | | B-3 | | 40° C. | | |

In Table 3, styrene/n-BA represents the amounts of styrene and n-butyl acrylate, and in the treatment process, “Y” represents implementation and “N” represents non-implementation.

TABLE 4

| | SPb − | Domain | | | | | |
|---|---|---|---|---|---|---|---|
| | SPc | diameter | Number of | G′(60) | G′(100) | G′(60)/ | D4 |
| | (J/cm³)^{0.5} | (μm) | domain | (Pa) | (Pa) | G′(100) | (μm) |
| Toner 1 | 1.60 | 0.04 | 985 | 8.2 × 10⁷ | 7.4 × 10⁴ | 1.1 × 10³ | 7.5 |
| Toner 2 | 2.68 | 0.10 | 282 | 8.2 × 10⁷ | 7.4 × 10⁴ | 1.1 × 10³ | 7.5 |
| Toner 3 | 2.03 | 0.05 | 964 | 8.2 × 10⁷ | 7.4 × 10⁴ | 1.1 × 10³ | 7.5 |
| Toner 4 | 2.68 | 0.06 | 933 | 8.2 × 10⁷ | 7.4 × 10⁴ | 1.1 × 10³ | 7.5 |
| Toner 5 | 2.03 | 0.12 | 257 | 8.2 × 10⁷ | 7.4 × 10⁴ | 1.1 × 10³ | 7.5 |
| Toner 6 | 2.03 | 0.20 | 153 | 8.2 × 10⁷ | 7.4 × 10⁴ | 1.1 × 10³ | 7.5 |
| Toner 7 | 1.50 | 0.04 | 974 | 1.1 × 10⁸ | 7.4 × 10⁴ | 1.5 × 10³ | 7.5 |
| Toner 8 | 1.65 | 0.05 | 958 | 6.8 × 10⁷ | 5.8 × 10⁴ | 1.2 × 10³ | 7.5 |
| Toner 9 | 1.57 | 0.07 | 894 | 9.4 × 10⁷ | 7.4 × 10⁴ | 1.3 × 10³ | 7.5 |
| Toner 10 | 1.54 | 0.09 | 319 | 1.0 × 10⁸ | 7.4 × 10⁴ | 1.4 × 10³ | 7.5 |
| Toner 11 | 1.65 | 0.62 | 85 | 8.2 × 10⁷ | 7.4 × 10⁴ | 1.1 × 10³ | 7.5 |
| Toner 12 | 1.65 | 1.28 | 12 | 8.2 × 10⁷ | 7.4 × 10⁴ | 1.1 × 10³ | 7.5 |
| Toner 13 | 1.65 | 1.55 | 8 | 6.5 × 10⁷ | 7.4 × 10⁴ | 8.8 × 10² | 7.5 |
| Toner 14 | 1.60 | 0.05 | 959 | 8.4 × 10⁷ | 9.2 × 10⁴ | 9.1 × 10² | 7.5 |
| Toner 15 | 1.60 | 0.04 | 992 | 8.1 × 10⁷ | 4.8 × 10⁴ | 1.7 × 10³ | 7.5 |
| Toner 16 | 1.60 | 0.06 | 924 | 1.6 × 10⁸ | 7.4 × 10⁴ | 2.2 × 10³ | 7.5 |
| Toner 17 | 1.60 | 0.06 | 918 | 1.6 × 10⁸ | 9.2 × 10⁴ | 1.7 × 10³ | 7.5 |
| Toner 18 | 1.26 | 0.04 | 972 | 8.2 × 10⁷ | 7.4 × 10⁴ | 1.1 × 10³ | 7.5 |
| Toner 19 | 1.46 | 1.51 | 8 | 1.5 × 10⁸ | 7.4 × 10⁴ | 2.0 × 10³ | 7.5 |
| Toner 20 | 1.06 | 1.82 | 6 | 2.2 × 10⁸ | 1.4 × 10⁵ | 1.6 × 10³ | 7.5 |
| Toner 21 | 1.05 | 1.85 | 6 | 3.4 × 10⁸ | 1.4 × 10⁵ | 2.4 × 10³ | 7.5 |
| Toner 22 | 1.64 | 2.06 | 4 | 4.2 × 10⁸ | 1.4 × 10⁵ | 3.0 × 10³ | 7.5 |
| Toner 23 | — | 0.15 | 214 | 6.8 × 10⁷ | 5.8 × 10⁴ | 1.2 × 10³ | 7.5 |
| Toner 24 | — | 0.20 | 149 | 6.8 × 10⁷ | 5.8 × 10⁴ | 1.2 × 10³ | 7.5 |

### Examples 1 to 18 and Comparative Examples 1 to 6

Evaluation was performed using the above toners 1 to 24 in combinations shown in Table 5. The evaluation results are shown in Table 5.

The evaluation method and evaluation criteria of the present disclosure will be described below.

As the image-forming apparatus, a commercially available laser printer, LBP-712Ci (manufactured by CANON KABUSHIKI KAISHA), was modified such that the process speed can be changed from 50 mm/sec to 300 mm/sec and the fixation temperature from 140° C. to 220° C., and a commercially available process cartridge, a toner cartridge 040H (black) (manufactured by CANON KABUSHIKI KAISHA), were used. The product toner was drawn out from the inside of the cartridge, and the cartridge was cleaned by an air blow and was then filled with 165 g of a toner of the present disclosure. Product toners of yellow, magenta, and cyan were drawn out from the respective stations, and yellow, magenta, and cyan cartridges with an invalid remaining toner quantity detection mechanism were inserted into the stations.

### Gloss Reduction

Ten sheets of a solid black image with a toner bearing amount of 0.50 mg/cm² were output using BROCHURE PAPER 150 g GLOSSY paper (manufactured by HP Inc., 150 g/m²) in a normal temperature and normal humidity environment (25° C./50% RH, hereinafter referred to as N/N environment) at a process speed of 70 mm/sec and a fixation temperature of 200° C.

The image gloss of the 10th image was measured at the center in the horizontal and vertical directions using a gloss meter. Subsequently, the image was stored in a high temperature and high humidity environment (30° C./80% RH) for 30 days. Subsequently, the gloss was measured similarly, and the gloss reduction was evaluated from the difference between the glosses before and after the storage. The gloss meter used was a handy gloss meter PG-1 (manufactured by Nippon Denshoku Industries, Co., Ltd.). In the measurement of gloss, the light projection and light reception angles were both set to 75°.
A: a gloss reduction of 2 or less;
B: a gloss reduction of greater than 2 and 5 or less;
C: a gloss reduction of greater than 5 and 10 or less; and
D: a gloss reduction of greater than 10.

### Gloss Unevenness

The glosses of the 10th image were measured at a point of 2 cm from the top of the image in the center in the vertical direction and at a point of 2 cm from the bottom of the image in the center in the horizontal direction. The gloss unevenness was evaluated from the difference in the glosses at the upper end and the lower end.
A: a gloss difference of 1 or less;
B: a gloss difference of greater than 1 and 2 or less;
C: a gloss difference of greater than 2 and 5 or less; and
D: a gloss difference of greater than 5.

### Low-Temperature Fixability

Ten sheets of a solid black image with a toner bearing amount of 0.50 mg/cm² were output using high white paper GF-C081 (manufactured by CANON KABUSHIKI KAISHA, 81.4 g/m²) in a normal temperature and normal humidity environment (25° C./50% RH, hereinafter referred to as N/N environment) at a process speed of 300 mm/sec and a fixation temperature of 220° C. Subsequently, the fixation temperature was lowered in 5° C. increments, and evaluation was performed until white spots occurred on the 10th image. The low-temperature fixability was evaluated from the temperature at which white spots occurred.
A: the temperature at which white spots occurred was 150° C. or less;
B: the temperature at which white spots occurred was 155° C. or higher and 170° C. or less;
C: the temperature at which white spots occurred was 175° C. or higher and 195° C. or less; and
D: the temperature at which white spots occurred was 200° C. or higher. Blocking resistance

Five grams of a toner was weighed in a plastic cup and was stored in an environment of 55° C./10% RH for 72 hours. Subsequently, the blocking resistance was evaluated from the aggregation state of the toner based on the following evaluation criteria:
A: no change was observed from before the storage;
B: aggregation was partially observed but was loosened by applying vibration;
C: aggregation was partially observed but was loosened by crushing with a spatula; and
D: aggregation was observed and was not loosened even when crushed with a spatula.

### Wax Bleeding

The wettability of a toner was evaluated using a wettability evaluation device. Subsequently, 5 g of a toner was weighed in a plastic cup and was stored in an environment of 40° C./95% RH for 30 days. The wettability was then similarly measured, and the wax bleeding was evaluated from the difference in the wettability before and after the storage. The wettability evaluation device used was a powder wettability tester “WET-100P” (manufactured by Rhesca Co., Ltd.). The wettability was measured by the following procedure. When the change of wettability becomes large, it is suggested that the wax bleeds out to the surface of the toner.

### Wettability Measurement Procedure

A fluorine resin-coated spindle-type rotor with a length of 25 mm and a maximum barrel diameter of 8 mm was placed in a cylindrical glass container with a diameter of 5 cm and a thickness of 1.75 mm. In the cylindrical glass container, 60.0 mL of distilled water was placed and treated with an ultrasonic disperser for 5 minutes in order to remove bubbles and so on. 0.1 g of a toner was precisely weighed and added to the container to prepare a measurement sample liquid. Methanol was continuously added to the measurement sample liquid at a dripping speed of 0.8 mL/min through the powder wettability tester while agitating the spindle-type rotor in the cylindrical glass container using a magnetic stirrer at a speed of 300 rpm. The permeability was measured with light of a wavelength of 780 nm, and a methanol-dripping permeability curve was produced. The methanol concentration (TA) when the permeability was 50% was read from the obtained methanol-dripping permeability curve. The methanol concentration (TA; vol %) is a value calculated by (volume of methanol in cylindrical glass container/volume of mixture of methanol and water in cylindrical glass container)×100.
A: a change in wettability was 3% or less;
B: a change in wettability was greater than 3% and 5% or less;
C: a change in wettability was greater than 5% and 10% or less; and
D: a change in wettability was greater than 10%.

TABLE 5

| | | Gloss | | | | Blocking | Wax | | Gloss | |
|---|---|---|---|---|---|---|---|---|---|---|
| | | reduction | | Fixability | | resistance | bleeding | | unevenness | |
| Example 1 | Toner 1 | A | 1 | A | 135° C. | A | A | 1% | A | 0 |
| Example 2 | Toner 2 | A | 2 | A | 135° C. | A | A | 2% | A | 0 |
| Example 3 | Toner 3 | B | 3 | A | 135° C. | A | A | 3% | A | 1 |
| Example 4 | Toner 4 | A | 2 | A | 135° C. | B | A | 2% | A | 0 |
| Example 5 | Toner 5 | B | 3 | A | 135° C. | B | A | 3% | A | 1 |
| Example 6 | Toner 6 | C | 7 | A | 135° C. | A | A | 3% | A | 1 |
| Example 7 | Toner 7 | A | 1 | C | 175° C. | A | A | 1% | A | 0 |
| Example 8 | Toner 8 | B | 3 | A | 130° C. | B | B | 4% | A | 0 |
| Example 9 | Toner 9 | A | 1 | B | 155° C. | C | A | 1% | A | 0 |
| Example 10 | Toner 10 | A | 1 | C | 175° C. | C | A | 1% | A | 0 |
| Example 11 | Toner 11 | A | 1 | A | 140° C. | A | A | 3% | A | 1 |
| Example 12 | Toner 12 | A | 1 | B | 155° C. | A | B | 5% | A | 1 |
| Example 13 | Toner 13 | A | 1 | B | 155° C. | B | C | 8% | A | 1 |
| Example 14 | Toner 14 | A | 1 | A | 140° C. | A | A | 1% | A | 1 |
| Example 15 | Toner 15 | A | 1 | A | 130° C. | B | A | 1% | B | 2 |
| Example 16 | Toner 16 | A | 1 | A | 140° C. | A | A | 1% | B | 2 |
| Example 17 | Toner 17 | A | 1 | A | 145° C. | A | A | 1% | C | 5 |
| Example 18 | Toner 18 | A | 1 | A | 135° C. | A | A | 1% | A | 0 |
| Comparative | Toner 18 | A | 1 | D | 200° C. | A | A | 3% | C | 4 |
| Example 1 | | | | | | | | | | |
| Comparative | Toner 19 | A | 1 | D | 210° C. | A | A | 3% | D | 6 |
| Example 2 | | | | | | | | | | |
| Comparative | Toner 20 | A | 1 | D | 215° C. | A | A | 3% | D | 7 |
| Example 3 | | | | | | | | | | |
| Comparative | Toner 21 | A | 1 | D | 220° C. | A | A | 3% | D | 6 |
| Example 4 | | | | | | | | | | |
| Comparative | Toner 22 | D | 12 | A | 130° C. | B | B | 5% | A | 0 |
| Example 5 | | | | | | | | | | |
| Comparative | Toner 23 | D | 15 | A | 130° C. | B | B | 5% | A | 0 |
| Example 6 | | | | | | | | | | |

According to the present disclosure, it is possible to provide a toner, a process cartridge, and an image-forming apparatus in which the fixability in a high-speed fixing process, the gloss control of images, and the suppression of the decrease in image gloss can be simultaneously achieved.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-006519, filed Jan. 17, 2025 and No. 2025-245143, filed Dec. 11, 2025, which are hereby incorporated by reference herein in their entirety.

What is claimed is:

1. A toner comprising:
a toner particle containing a binder resin, a block copolymer A, and an ester wax B, wherein
the binder resin contains a styrene-acrylic copolymer,
a content of the styrene-acrylic copolymer in the binder resin is 50 mass % or more,
the block copolymer A is a block copolymer including a polyolefine segment and a polystyrene segment, and the polyolefine segment includes an olefine unit C represented by any of formulae (1) to (4): 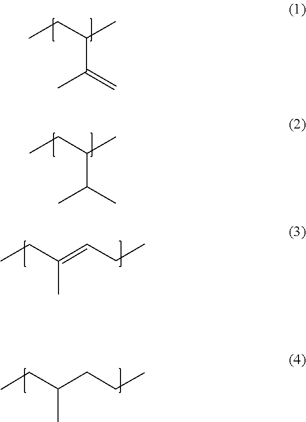
the ester wax B is miscible with 100 parts by mass of a styrene-n-butyl acrylate copolymer α having the following composition in an amount of 15.0 parts by mass or more at 100° C.:
the styrene-n-butyl acrylate copolymer α is a copolymer of 75 parts by mass of a styrene monomer and 25 parts by mass of an n-butyl acrylate monomer,
the styrene-n-butyl acrylate copolymer α has a weight-average molecular weight of 29,000 or more and 31,000 or less, and
the ester wax B is an ester compound having a structure of formula (5) or a structure of formula (6): 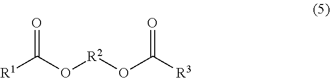
in formula (5), R¹ and R³ each independently represent an n-alkyl group having 13 to 21 carbon atoms, and R² represents an alkylene group having 2 to 8 carbon atoms; 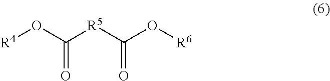
in formula (6), R⁴ and R⁶ each independently represent an n-alkyl group having 14 to 22 carbon atoms, and R⁵ represents a single bond or an alkylene group having 1 to 6 carbon atoms.

2. The toner according to claim 1, wherein the olefine unit C is a unit of formula (1) or a unit of formula (2).

3. The toner according to claim 1, wherein the ester wax B is an ester compound having a structure represented by formula (7): 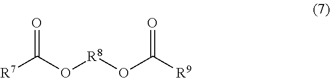
in formula (7), R⁷ and R⁹ each independently represent an n-alkyl group having 17 to 21 carbon atoms, and R⁸ represents an alkylene group having 2 carbon atoms.

4. The toner according to claim 1, wherein when the olefine unit C has a solubility parameter of SPc (J/cm³)^{0.5} and the ester wax B has a solubility parameter of SPb (J/cm³)^{0.5}, a value of a difference between SPb and SPc (SPb−SPc) is 1.50 or more and 3.00 or less.

5. The toner according to claim 1, wherein domains of the ester wax B are present in a cross-section of the toner particle observed with a scanning transmission electron microscope, an average number of the domains is 100 or more per one cross-section of the toner particle, and an average major axis of the domains (r1) is 1.00 μm or less.

6. A process cartridge attachable to and detachable from an image-forming apparatus, the process cartridge comprising:
a toner, and
a toner container accommodating the toner, wherein
the toner comprises a toner particle containing a binder resin, a block copolymer A, and an ester wax B,
the binder resin contains a styrene-acrylic copolymer,
a content of the styrene-acrylic copolymer in the binder resin is 50 mass % or more,
the block copolymer A is a block copolymer including a polyolefine segment and a polystyrene segment, and the polyolefine segment includes an olefine unit C represented by any of formulae (1) to (4): 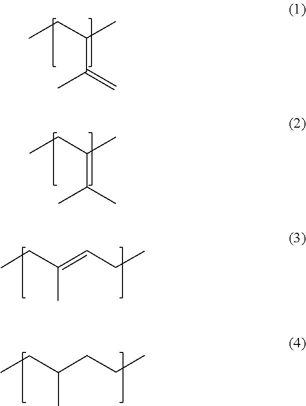
the ester wax B is miscible with 100 parts by mass of a styrene-n-butyl acrylate copolymer α having the following composition in an amount of 15.0 parts by mass or more at 100° C.:
the styrene-n-butyl acrylate copolymer α is a copolymer of 75 parts by mass of a styrene monomer and 25 parts by mass of an n-butyl acrylate monomer,
the styrene-n-butyl acrylate copolymer α has a weight-average molecular weight of 29,000 or more and 31,000 or less, and
the ester wax B is an ester compound having a structure of formula (5) or a structure of formula (6): 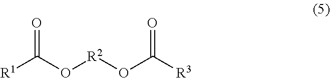
in formula (5), R¹ and R³ each independently represent an n-alkyl group having 13 to 21 carbon atoms, and R² represents an alkylene group having 2 to 8 carbon atoms); 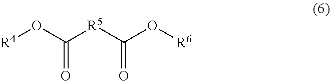
in formula (6), R⁴ and R⁶ each independently represent an n-alkyl group having 14 to 22 carbon atoms, and R⁵ represents a single bond or an alkylene group having 1 to 6 carbon atoms.

7. An image-forming apparatus comprising:
a toner;
a toner carrier carrying the toner;
an electrostatic latent image carrier;
a charging device that charges the surface of the electrostatic latent image carrier by a charging member;
an electrostatic latent image-forming device forming an electrostatic latent image on the charged electrostatic latent image carrier;
a developing device for developing the electrostatic latent image using the toner to form a toner image on the electrostatic latent image carrier;
a transfer device for transferring the toner image to a recording medium; and
a fixing device for fixing the toner image transferred on the recording medium to the recording medium, wherein
the toner comprises a toner particle containing a binder resin, a block copolymer A, and an ester wax B,
the binder resin contains a styrene-acrylic copolymer,
a content of the styrene-acrylic copolymer in the binder resin is 50 mass % or more,
the block copolymer A is a block copolymer including a polyolefine segment and a polystyrene segment, and the polyolefine segment includes an olefine unit C represented by any of formulae (1) to (4): 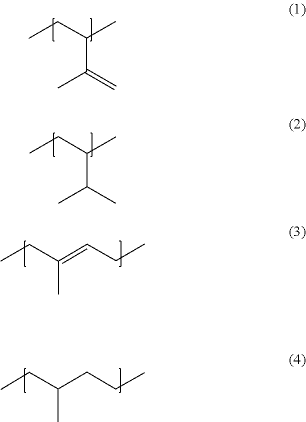
the ester wax B is miscible with 100 parts by mass of a styrene-n-butyl acrylate copolymer α having the following composition in an amount of 15.0 parts by mass or more at 100° C.:
the styrene-n-butyl acrylate copolymer α is a copolymer of 75 parts by mass of a styrene monomer and 25 parts by mass of an n-butyl acrylate monomer,
the styrene-n-butyl acrylate copolymer α has a weight-average molecular weight of 29,000 or more and 31,000 or less, and
the ester wax B is an ester compound having a structure of formula (5) or a structure of formula (6): 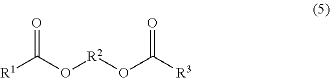
in formula (5), R¹ and R³ each independently represent an n-alkyl group having 13 to 21 carbon atoms, and R² represents an alkylene group having 2 to 8 carbon atoms; 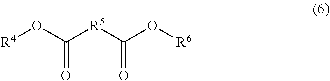
in formula (6), R⁴ and R⁶ each independently represent an n-alkyl group having 14 to 22 carbon atoms, and R⁵ represents a single bond or an alkylene group having 1 to 6 carbon atoms.
